(19) United States
(12) Patent Application Publication
(10) Pub. No.: US 2026/0250811 A1
(43) Pub. Date: Aug. 27, 2026

(54) HIGH-STRENGTH STEEL SHEET AND MANUFACTURING METHOD THEREFOR

(71) Applicant: JFE STEEL CORPORATION, Tokyo (JP)

(72) Inventors: Ryusuke ISHITO, Chiyoda-ku, Tokyo (JP); Junya TOBATA, Chiyoda-ku, Tokyo (JP); Hidekazu MINAMI, Chiyoda-ku, Tokyo (JP); Yuki TOJI, Chiyoda-ku, Tokyo (JP)

(73) Assignee: JFE STEEL CORPORATION, Tokyo (JP)

(21) Appl. No.: 19/160,118

(22) PCT Filed: Mar. 5, 2024
(86) PCT No.: PCT/JP2024/008249

§ 371 Date: Aug. 27, 2025

(30) Foreign Application Priority Data
Mar. 6, 2023 (JP) 2023-033481

(51) Int. Cl. C22C 38/04; B32B 15/01; C21D 1/18; C21D 6/00; C21D 8/0221; C21D 8/0247; C21D 9/46; C22C 38/00; C22C 38/02; C22C 38/06; C22C 38/08; C22C 38/10; C22C 38/12; C22C 38/14; C22C 38/16; C22C 38/26; C22C 38/38; C22C 38/60

(52) U.S. Cl. CPC C22C 38/04; B32B 15/013; C21D 1/18; C21D 6/001; C21D 6/002; C21D 6/005; C21D 6/007; C21D 6/008; C21D 8/0226; C21D 8/0236; C21D 8/0263; C21D 9/46; C22C 38/001; C22C 38/002; C22C 38/005; C22C 38/008; C22C 38/02; C22C 38/06; C22C 38/08; C22C 38/10; C22C 38/12; C22C 38/14; C22C 38/16; C22C 38/26; C22C 38/38; C22C 38/60; C21D 2211/001; C21D 2211/002; C21D 2211/005; C21D 2211/008

(57) ABSTRACT

A high strength steel sheet contains, by mass, C: 0.030%-0.500%, Si: 0.50%-2.50%, Mn: 1.50%-5.00%, P: not more than 0.100%, S: not more than 0.0200%, Al: not more than 1.000%, N: not more than 0.0100%, O: not more than 0.0100%, and Nb: 0.005%-0.100%, with a balance consisting of Fe and inevitable impurities, an amount of martensite is not less than 60%, an amount of retained austenite is 3%-20%, and a total amount of ferrite and bainitic ferrite is more than 10%, an instability index k of retained austenite is less than 5.9, and an instability index d of retained austenite in an initial stage of working is less than 5.8.

### CROSS REFERENCE TO RELATED APPLICATIONS

This is the U.S. National Phase application of PCT/JP2024/008249, filed Mar. 5, 2024, which claims priority to Japanese Patent Application No. 2023-033481, filed Mar. 6, 2023, the disclosures of these applications being incorporated herein by reference in their entireties for all purposes.

### FIELD OF THE INVENTION

The present invention relates to a high strength steel sheet and a method for manufacturing the same.

### BACKGROUND OF THE INVENTION

For the purpose of achieving both an improvement in fuel efficiency (reduction in CO₂ emission) owing to reduced weight of vehicle bodies and an improvement in collision resistance performance, strengthening of thin steel sheets for automobiles are in progress, and new laws and regulations are also successively introduced.

In recent years, cases of applying high strength steel sheets having a tensile strength (TS) of not less than 980 MPa (for instance, see Patent Literatures 1 to 3) to main structural parts of automobiles are increasing for the purpose of increasing the strength of vehicle bodies.

### PATENT LITERATURE

Patent Literature 1: JP 2015-193897 A
Patent Literature 2: WO 2019/187090 A1
Patent Literature 3: WO 2020/174805 A1

### SUMMARY OF THE INVENTION

While, conventionally, hot press forming of high strength steel sheets have been vigorously discussed, recently, cold press forming is again being considered from cost and productivity viewpoints.

However, when a component is obtained by cold press forming of a high strength steel sheet having a TS of not less than 980 MPa, delayed fracture may occur due to an increase in residual stress in the component or a deterioration of delayed fracture resistance of the steel sheet itself.

The delayed fracture is a phenomenon in which when a formed component is placed in a hydrogen entering environment, hydrogen enters a steel sheet constituting the component, whereby interatomic bonding strength decreases or local deformation occurs, thus causing fine cracks, and development of the fine cracks leads to fracturing.

Aside from that, high strength steel sheets used in automobiles are required to have excellent ductility from a formability viewpoint.

Further, skeletal parts of automobiles have many end surfaces formed through shearing, and such shear end surfaces are required to be free from cracking caused by bending forming (bending).

The form of a shear end surface depends on the shear clearance, and occurrence of cracking at a shear end surface also depends on the shear clearance.

Hence, high strength steel sheets used in automobiles need to have a wide optimal clearance range with respect to bending forming of shear end surfaces.

Therefore, an object of aspects of the present invention is to provide a high strength steel sheet having a tensile strength (TS) of not less than 980 MPa, having excellent ductility and excellent delayed fracture resistance, and having a wide optimal clearance range with respect to bending forming of a shear end surface, as well as a method for manufacturing the same.

The present inventors found, through an earnest study, that employing the configuration described below enables the achievement of the above-mentioned object. Aspects of the invention have been thus completed.

Specifically, aspects of the present invention include the following [1] to [5].

[1] A high strength steel sheet comprising a steel sheet,
wherein the steel sheet has a chemical composition including, by mass,
C in an amount of not less than 0.030% and not more than 0.500%,
Si in an amount of not less than 0.50% and not more than 2.50%,
Mn in an amount of not less than 1.50% and not more than 5.00%,
P in an amount of not more than 0.100%
S in an amount of not more than 0.0200%,
Al in an amount of not more than 1.000%,
N in an amount of not more than 0.0100%,
O in an amount of not more than 0.0100%, and
Nb in an amount of not less than 0.005% and not more than 0.100%,
with a balance consisting of Fe and inevitable impurities,
the steel sheet has a microstructure in which an amount of martensite is not less than 60%, an amount of retained austenite is not less than 3% and not more than 20%, and a total amount of ferrite and bainitic ferrite is more than 10%,
an instability index k of retained austenite is less than 5.9, and
an instability index d of retained austenite in an initial stage of working is less than 5.8.

[2] The high strength steel sheet according to [1] above,
wherein the chemical composition further includes at least one element selected from the group consisting of, by mass,
Ti in an amount of not more than 0.200%,
V in an amount of not more than 0.200%,
Ta in an amount of not more than 0.10%,
W in an amount of not more than 0.10%,
B in an amount of not more than 0.0100%,
Cr in an amount of not more than 1.00%,
Mo in an amount of not more than 1.00%,
Ni in an amount of not more than 1.00%,
Co in an amount of not more than 0.010%,
Cu in an amount of not more than 1.00%,
Sn in an amount of not more than 0.200%,
Sb in an amount of not more than 0.200%,
Ca in an amount of not more than 0.0100%,
Mg in an amount of not more than 0.0100%,
REM in an amount of not more than 0.0100%,
Zr in an amount of not more than 0.100%,
Te in an amount of not more than 0.100%,
Hf in an amount of not more than 0.10%, and
Bi in an amount of not more than 0.200%.

[3] The high strength steel sheet according to [1] or [2] above, further comprising a plating layer on a surface of the steel sheet.

[4] A method for manufacturing the high strength steel sheet according to [1] or [2] above, the method comprising:
retaining a steel slab having the chemical composition according to [1] or [2] above at a slab heating temperature of not lower than 1,220° C. and then performing hot rolling to obtain a hot rolled steel sheet;
cooling the hot rolled steel sheet under a condition of an average cooling rate v₁ from 800° C. to 600° C. of not lower than 30° C./s and then performing pickling and cold rolling to obtain a cold rolled steel sheet;
performing a heat treatment A in which the cold rolled steel sheet is retained at a temperature Ti of not lower than 750° C. and not higher than 900° C. for 10 seconds or more and 1,000 seconds or less and then cooled to a cooling stop temperature Ta of not lower than 100° C. and not higher than (Ms point−80° C.),
   where, in the heat treatment A, an average cooling rate v₂ from 750° C. to 600° C. is lower than 20° C./s, an average cooling rate v₃ from the Ms point to the cooling stop temperature Ta is not higher than 150° C./s, and a tension F imparted to the cold rolled steel sheet from the Ms point to the cooling stop temperature Ta is not less than 5 MPa and not more than 100 MPa;
after the heat treatment A, performing a heat treatment B in which the cold rolled steel sheet is retained at a temperature T2 of not lower than the cooling stop temperature Ta and not higher than 450° C. for 5 seconds or more and 1,000 seconds or less and then cooled;
after the heat treatment B, performing a heat treatment C in which the cold rolled steel sheet is heated to a temperature T3 of not lower than 150° C. and not higher than 400° C. and then cooled without being retained at the temperature T3,
   where, in the heat treatment C, an average cooling rate v₄ from 150° C. to 50° C. is not lower than 1.0° C./s and not higher than 50.0° C./s; and
after the heat treatment A and before the heat treatment C, working the cold rolled steel sheet to impart an equivalent plastic strain of not less than 0.10% and not more than 5.00% to the cold rolled steel sheet,
wherein the Ms point is represented in a unit of ° C. and determined by Formula (a):

$$Ms = 519 - 474 \times [ \% C ] - 30.4 \times [ \% Mn ] - 12.1 \times [ \% Cr ] - 7.5 \times [ \% Mo ] - 17.7 \times [ \% Ni ] \qquad ( a )$$

in Formula (a), [% M] represents a content of an element M in the chemical composition, and when the element M is not contained, [% M] is 0.

[5] The method for manufacturing the high strength steel sheet according to [4] above,
wherein the cold rolled steel sheet is subjected to a plating treatment.

Aspects of the present invention can provide a high strength steel sheet having a tensile strength (TS) of not less than 980 MPa, having excellent ductility and excellent delayed fracture resistance, and having a wide optimal clearance range with respect to bending forming of a shear end surface, as well as a method for manufacturing the same.

### BRIEF DESCRIPTION OF THE DRAWINGS

FIG. 1 is a schematic view showing a specimen used in a tensile test.

FIG. 2 is a graph schematically showing the relation between tensile stress applied to a specimen and tensile strain during the tensile test.

FIG. 3 is an exemplary graph showing the relation between tensile strain c and the amount of retained austenite.

FIG. 4 is another exemplary graph showing the relation between tensile strain c and the amount of retained austenite.

FIG. 5 is still another exemplary graph showing the relation between tensile strain c and the amount of retained austenite.

### DETAILED DESCRIPTION OF EMBODIMENTS OF THE INVENTION

### [High Strength Steel Sheet]

A high strength steel sheet of the present embodiment (hereinafter also referred to as the “present high strength steel sheet”) includes a steel sheet, and may further include a plating layer on a surface of the steel sheet as described later.

The steel sheet included in the present high strength steel sheet has the chemical composition and microstructure (steel structure) which are to be described later, and satisfies an instability index k and an instability index d which are to be described later.

The term “high strength” means having a tensile strength (TS) of not less than 980 MPa.

The high strength steel sheet has a tensile strength (TS) of not less than 980 MPa, has excellent ductility and excellent delayed fracture resistance, and has a wide optimal clearance range with respect to bending forming of a shear end surface.

Hereinafter, the optimal clearance range with respect to bending forming of a shear end surface is also simply called “optimal clearance range.”

In summary, the present inventors found the following facts through an earnest study.

(1) By having the amount of martensite being not less than 60%, a TS of not less than 980 MPa can be achieved.
(2) By having the total amount of ferrite and bainitic ferrite being more than 10% and the amount of retained austenite being not less than 3%, excellent ductility can be achieved.
(3) By having the instability index d of retained austenite in an initial stage of working being less than 5.8 and the amount of retained austenite being not more than 20%, excellent delayed fracture resistance can be achieved.
(4) By having the instability index k of retained austenite being less than 5.9 and the instability index d of retained austenite in an initial stage of working being less than 5.8, a wide optimal clearance range can be achieved.

The use of the present high strength steel sheet for, for instance, structural parts of automobiles allows vehicle bodies to be lighter, resulting in improved fuel consumption. Thus, the industrial utility value is quite high.

### <Steel Sheet>

First, the steel sheet included in the present high strength steel sheet is described.

The thickness of the steel sheet is not particularly limited and is, for example, not less than 0.5 mm and not more than 3.0 mm.

### <<Chemical Composition>>

The chemical composition of the steel sheet included in the present high strength steel sheet (hereinafter, also referred to as “present chemical composition”) is described.

The unit “%” used for the chemical composition means “mass %” unless otherwise noted.

(C: Not Less than 0.030% and not More than 0.500%)

C is an element that is one of important basic components of steel and that influences the amount of martensite and the total amount of ferrite and bainitic ferrite.

When the amount of C is too small, the amount of martensite decreases, and this makes it difficult to achieve a TS of not less than 980 MPa. Hence, the C content is not less than 0.030%, preferably not less than 0.050%, and more preferably not less than 0.100%.

Meanwhile, when the amount of C is too large, martensite embrittles, resulting in lower delayed fracture resistance. Hence, the C content is not more than 0.500%, preferably not more than 0.400%, and more preferably not more than 0.350%.

(Si: Not Less than 0.50% and not More than 2.50%)

Si is an element that is one of important basic components of steel and that influences the TS and the amount of retained austenite.

When the amount of Si is too small, the strength of martensite decreases, and this makes it difficult to achieve a TS of not less than 980 MPa. Hence, the Si content is not less than 0.50%, preferably not less than 0.55%, and more preferably not less than 0.60%.

Meanwhile, when the amount of Si is too large, retained austenite excessively increases, and this leads to lower delayed fracture resistance. Hence, the Si content is not more than 2.50%, preferably not more than 2.00%, and more preferably not more than 1.80%.

(Mn: Not Less than 1.50% and not More than 5.00%)

Mn is an element that is one of important basic components of steel and that influences the amount of martensite and the total amount of ferrite and bainitic ferrite.

When the amount of Mn is too small, the amount of martensite decreases, and this makes it difficult to achieve a TS of not less than 980 MPa. Hence, the Mn content is not less than 1.50%, preferably not less than 2.00%, and more preferably not less than 2.20%.

Meanwhile, when the amount of Mn is too large, martensite embrittles, resulting in lower delayed fracture resistance. Hence, the Mn content is not more than 5.00%, preferably not more than 4.50%, and more preferably not more than 4.00%.

(P: Not More than 0.100%)

P segregates in a prior austenite grain boundary to embrittle the grain boundary and thus embrittle the steel sheet, resulting in lower delayed fracture resistance. Hence, the P content is not more than 0.100%, preferably not more than 0.070%, and more preferably not more than 0.030%.

The lower limit thereof is not particularly limited. However, P is a solid solution strengthening element and is capable of increasing the strength of the steel sheet. Hence, the P content is preferably not less than 0.001%, more preferably not less than 0.003%, and even more preferably not less than 0.005%.

(S: Not More than 0.0200%)

S is present as a sulfide and embrittles the steel sheet, resulting in lower delayed fracture resistance. Hence, the S content is not more than 0.0200%, preferably not more than 0.0050%, and more preferably not more than 0.0025%.

While the lower limit is not particularly limited, the S content is preferably not less than 0.0001%, more preferably not less than 0.0003%, and even more preferably not less than 0.0005% due to production engineering constraints.

(Al: Not More than 1.000%)

Al is present as an oxide and embrittles the steel sheet, resulting in lower delayed fracture resistance. Hence, the Al content is not more than 1.000%, preferably not more than 0.500%, more preferably not more than 0.150%, and even more preferably not more than 0.070%.

The lower limit thereof is not particularly limited. However, Al is capable of suppressing the generation of a carbide during heat treatments, which will be described later, and promoting the generation of retained austenite. Hence, the Al content is preferably not less than 0.001%, more preferably not less than 0.005%, and even more preferably not less than 0.010%.

(N: Not More than 0.0100%)

N is present as a nitride and embrittles the steel sheet, resulting in lower delayed fracture resistance. Hence, the N content is not more than 0.0100%, preferably not more than 0.0080%, and more preferably not more than 0.0050%.

While the lower limit is not particularly limited, the N content is preferably not less than 0.0001%, more preferably not less than 0.0005%, and even more preferably not less than 0.0010% due to production engineering constraints.

(O: Not More than 0.0100%)

O is present as an oxide and embrittles the steel sheet, resulting in lower delayed fracture resistance. Hence, the O content is not more than 0.0100%, preferably not more than 0.0080%, and more preferably not more than 0.0050%.

While the lower limit is not particularly limited, the O content is preferably not less than 0.0001%, more preferably not less than 0.0007%, and even more preferably not less than 0.0015% due to production engineering constraints.

(Nb: Not Less than 0.005% and not More than 0.100%)

The present inventors found, through an earnest study, that Nb influences the instability index k of retained austenite.

When the amount of Nb is too small, the structure after heat treatments to be described later coarsens, and the instability index k of retained austenite increases. This results in a narrower optimal clearance range. Hence, the Nb content is not less than 0.005%, preferably not less than 0.008%, and more preferably not less than 0.010%.

Meanwhile, when the amount of Nb is too large, martensite embrittles, resulting in lower delayed fracture resistance. Hence, the Nb content is not more than 0.100%, preferably not more than 0.080%, and more preferably not more than 0.050%.

### (Other Elements)

The present chemical composition may further include at least one element (another element) selected from the group consisting of the elements described below, in percentage by mass.

### ((Ti and V))

When the amounts of Ti and V are too large, a large number of coarse precipitates and inclusions are generated, and the steel sheet embrittles, resulting in lower delayed fracture resistance. Hence, the contents of Ti and V are each not more than 0.200%, preferably not more than 0.150%, and more preferably not more than 0.100%.

The lower limits thereof are not particularly limited. However, Ti and V form fine carbides, nitrides, or carbonitrides during hot rolling or heat treatments, which will be described later, thereby increasing the strength of the steel sheet. Hence, the contents of Ti and V are each preferably not less than 0.001%, more preferably not less than 0.005%, and even more preferably not less than 0.015%.

### ((Ta and W))

When the amounts of Ta and W are too large, a large number of coarse precipitates and inclusions are generated, and the steel sheet embrittles, resulting in lower delayed fracture resistance. Hence, the contents of Ta and W are each not more than 0.10%, preferably not more than 0.09%, and more preferably not more than 0.08%.

The lower limits thereof are not particularly limited. However, Ta and W form fine carbides, nitrides, or carbonitrides during hot rolling or heat treatments, which will be described later, thereby increasing the strength of the steel sheet. Hence, the contents of Ta and W are each preferably not less than 0.01%, more preferably not less than 0.03%, and even more preferably not less than 0.05%.

### ((B))

When the amount of B is too large, cracks are generated inside the steel sheet during casting or hot rolling, and the steel sheet embrittles, resulting in lower delayed fracture resistance. Hence, the B content is not more than 0.0100%, preferably not more than 0.0080%, and more preferably not more than 0.0060%.

The lower limit thereof is not particularly limited. However, B segregates in a prior austenite grain boundary during heat treatments to be described later, thus improving the hardenability. Hence, the B content is preferably not less than 0.0003%, more preferably not less than 0.0005%, and even more preferably not less than 0.0010%.

### ((Cr, Mo, and Ni))

When the amounts of Cr, Mo, and Ni are too large, coarse precipitates and inclusions increase, and the steel sheet embrittles, resulting in lower delayed fracture resistance. Hence, the contents of Cr, Mo, and Ni are each not more than 1.00%, preferably not more than 0.80%, and more preferably not more than 0.50%.

The lower limits thereof are not particularly limited. However, since Cr, Mo, and Ni are elements that improve the hardenability, the contents of Cr, Mo, and Ni are each preferably not less than 0.01%, more preferably not less than 0.04%, and even more preferably not less than 0.08%.

### ((Co))

When the amount of Co is too large, coarse precipitates and inclusions increase, and the steel sheet embrittles, resulting in lower delayed fracture resistance. Hence, the Co content is not more than 0.010%, preferably not more than 0.008%, and more preferably not more than 0.006%.

The lower limit thereof is not particularly limited. However, since Co is an element that improves the hardenability, the Co content is preferably not less than 0.001%, more preferably not less than 0.003%, and even more preferably not less than 0.005%.

### ((Cu))

When the amount of Cu is too large, coarse precipitates and inclusions increase, and the steel sheet embrittles, resulting in lower delayed fracture resistance. Hence, the Cu content is not more than 1.00%, preferably not more than 0.80%, and more preferably not more than 0.60%.

The lower limit thereof is not particularly limited. However, since Cu is an element that improves the hardenability, the Cu content is preferably not less than 0.01%, more preferably not less than 0.03%, and even more preferably not less than 0.05%.

### ((Sn))

When the amount of Sn is too large, cracks are generated inside the steel sheet during casting or hot rolling, and the steel sheet embrittles, resulting in lower delayed fracture resistance. Hence, the Sn content is not more than 0.200%, preferably not more than 0.150%, and more preferably not more than 0.100%.

The lower limit thereof is not particularly limited. However, since Sn is an element that improves the hardenability, the Sn content is preferably not less than 0.001%, more preferably not less than 0.010%, and even more preferably not less than 0.020%.

### ((Sb))

When the amount of Sb is too large, coarse precipitates and inclusions increase, and the steel sheet embrittles, resulting in lower delayed fracture resistance. Hence, the Sb content is not more than 0.200%, preferably not more than 0.150%, and preferably not more than 0.100%.

The lower limit thereof is not particularly limited. However, since Sb is an element that controls the surface layer softening thickness and allows for adjustment of the strength, the Sb content is preferably not less than 0.001%, more preferably not less than 0.003%, and even more preferably not less than 0.005%.

### ((Ca, Mg, and REM))

When the amounts of Ca, Mg, and REM (rare earth metal) are too large, coarse precipitates and inclusions increase, and the steel sheet embrittles, resulting in lower delayed fracture resistance. Hence, the contents of Ca, Mg, and REM are each not more than 0.0100%, preferably not more than 0.0080%, and more preferably not more than 0.0050%.

The lower limits thereof are not particularly limited. However, Ca, Mg, and REM are elements that spheroidize the shapes of nitrides and sulfides and improve the ultimate deformability of the steel sheet. Hence, the contents of Ca, Mg, and REM are each preferably not less than 0.0005%, more preferably not less than 0.0010%, and even more preferably not less than 0.0015%.

### ((Zr and Te))

When the amounts of Zr and Te are too large, coarse precipitates and inclusions increase, and the steel sheet embrittles, resulting in lower delayed fracture resistance. Hence, the contents of Zr and Te are each not more than 0.100%, preferably not more than 0.080%, and more preferably not more than 0.060%.

The lower limits thereof are not particularly limited. However, Zr and Te are elements that spheroidize the shapes of nitrides and sulfides and improve the ultimate deformability of the steel sheet. Hence, the contents of Zr and Te are each preferably not less than 0.001%, more preferably not less than 0.008%, and even more preferably not less than 0.015%.

### ((Hf))

When the amount of Hf is too large, coarse precipitates and inclusions increase, and the steel sheet embrittles, resulting in lower delayed fracture resistance. Hence, the Hf content is not more than 0.10%, preferably not more than 0.09%, and more preferably not more than 0.08%.

The lower limit thereof is not particularly limited. However, Hf is an element that spheroidizes the shapes of nitrides and sulfides and improves the ultimate deformability of the steel sheet. Hence, the Hf content is preferably not less than 0.01%, more preferably not less than 0.02%, and even more preferably not less than 0.03%.

### ((Bi))

When the amount of Bi is too large, coarse precipitates and inclusions increase, and the steel sheet embrittles, resulting in lower delayed fracture resistance. Hence, the Bi content is not more than 0.200%, preferably not more than 0.150%, and more preferably not more than 0.100%.

The lower limit thereof is not particularly limited. However, since Bi is an element that reduces the segregation, the Bi content is preferably not less than 0.001%, more preferably not less than 0.020%, even more preferably not less than 0.050%, and particularly preferably not less than 0.090%.

With respect to the above-described other elements, when the content of an element is less than its preferable lower limit, the element does not impair the effect of aspects of the present invention and is therefore considered an inevitable impurity.

### (Balance)

The balance in the present chemical composition consists of Fe and inevitable impurities.

### <<Microstructure>>

Next, the microstructure of the steel sheet included in the present high strength steel sheet (hereinafter also referred to as “present microstructure”) is described.

(Total Amount of Ferrite and Bainitic Ferrite: More than 10%)

When the amounts of ferrite and bainitic ferrite are too small, it is difficult to achieve excellent ductility. Hence, the total amount of ferrite and bainitic ferrite is more than 10%, preferably not less than 11%, and more preferably not less than 13%.

The lower limit thereof is not particularly limited and is preferably not more than 45%, more preferably not more than 40%, and even more preferably not more than 35%.

The amounts of ferrite and bainitic ferrite are obtained in the following manner.

The steel sheet is polished to expose, as an observation surface, an L cross section at the ¼ sheet thickness position (the position corresponding to ¼ of the sheet thickness from the surface of the steel sheet in the depth direction). The observation surface is etched using 3 vol % Nital and then observed in 10 fields with a scanning electron microscope (SEM) at a magnification of 2,000×, whereby an SEM image of each field is obtained. In the SEM images, ferrite and bainitic ferrite are observed as recessed structures with their inside portions being flat. The area fraction (unit: %) of ferrite and bainitic ferrite in each SEM image is obtained, and the average of the obtained area fractions of the 10 fields is defined as the total amount of ferrite and bainitic ferrite.

(Amount of Retained Austenite: Not Less than 3% and not More than 20%)

The amount of retained austenite is not less than 3%, preferably not less than 5%, more preferably not less than 7%, and even more preferably not less than 8% because excellent ductility can be achieved.

Meanwhile, the amount of retained austenite is not more than 20%, preferably not more than 15%, and more preferably not more than 13% because excellent delayed fracture resistance can be achieved.

The amount of retained austenite is determined in the following manner.

The steel sheet is polished to expose an L cross section at a position 0.1 mm deeper than the ¼ sheet thickness position. This L cross section is further polished by 0.1 mm in the depth direction by chemical polishing to obtain an observation surface. For the observation surface, integral intensity ratios of diffraction peaks are determined using CoKα radiation in an X-ray diffraction (XRD) instrument. More specifically, integral intensity ratios between diffraction peaks of respective planes {200}, {220}, and {311} of fcc iron and those of respective planes {200}, {211}, and {220} of bcc iron are determined. The average of nine integral intensity ratios is defined as the volume fraction (unit: %) of the amount of retained austenite, and this is specified as the amount of retained austenite.

(Amount of Martensite: Not Less than 60%)

The amount of martensite is not less than 60%, preferably not less than 65%, and more preferably not less than 70% because a TS of not less than 980 MPa can be achieved.

Of plural types of martensite, tempered martensite is important in terms of the contribution to achievement of a high TS, and the amount of tempered martensite is preferably not less than 65%.

The amount of martensite is determined in the following manner.

First, the amount of retained austenite and the total amount of ferrite and bainitic ferrite are obtained by the foregoing methods. Next, the sum of those amounts is subtracted from 100%, and the obtained value (unit: %) is defined as the amount of martensite.

Accordingly, the amount of martensite herein includes both amounts of hardened martensite and tempered martensite.

It should be noted that the amount of retained austenite is the volume fraction as described above, and this is substantially equivalent to the area fraction. Accordingly, the amount of retained austenite is, together with the total amount of ferrite and bainitic ferrite which is the area fraction, subtracted from 100%.

<<Instability Index k: Less than 5.9>>

The present inventors found, through an earnest study, that the instability index k of retained austenite (also simply referred to as “instability index k”) influences the optimal clearance range.

When the instability index k is too high, the stability of retained austenite is low, and the retained austenite excessively transforms to hard martensite in shearing. This decreases the ultimate deformability of the steel sheet, resulting in a narrower optimal clearance range.

Hence, the instability index k is less than 5.9, preferably not more than 5.0, more preferably not more than 4.0, and even more preferably not more than 3.5.

While the lower limit is not particularly limited, the instability index k is for example not less than 1.0, preferably not less than 1.5, and more preferably not less than 2.0.

<<Instability Index d: Less than 5.8>>

The present inventors found, through an earnest study, that the instability index d of retained austenite in an initial stage of working (also simply referred to as “instability index d”) influences the delayed fracture resistance and the optimal clearance range.

When the instability index d is too high, the stability of retained austenite in an initial stage of working is low, and the retained austenite excessively transforms to hard martensite in the initial stage of working and would act as starting points of generation of delayed fractures in a hydrogen entering environment, thus lowering the delayed fracture resistance.

In addition, when the instability index d is too high, retained austenite excessively transforms to hard martensite in an initial stage of working, whereby the ultimate deformability of the steel sheet decreases, resulting in a narrower optimal clearance range.

Thus, the instability index d is less than 5.8, preferably not more than 5.0, more preferably not more than 4.0, and even more preferably not more than 3.5.

While the lower limit is not particularly limited, the instability index d is for example not less than −15.0, preferably not less than −10.0, and more preferably not less than −5.0.

The instability index k and the instability index d are determined in the following manner.

First, a tensile test to be described later (the details of which are described in EXAMPLES) is carried out to work a specimen (JIS No. 5 specimen) of a steel sheet.

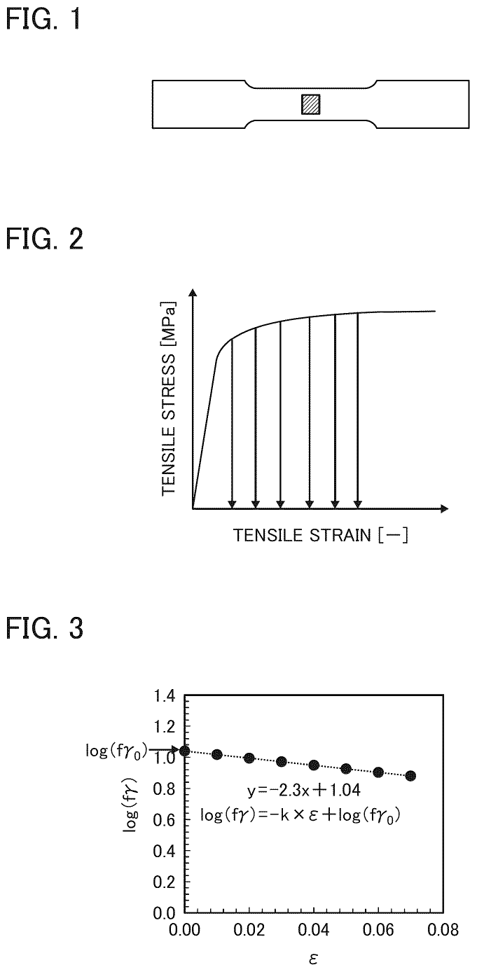

FIG. 1 is a schematic view showing a specimen used in the tensile test. FIG. 2 is a graph schematically showing the relation between tensile stress applied to a specimen 1 and tensile strain during the tensile test.

As shown in FIG. 2, tensile stress is applied to a specimen to impart tensile strain (tensile plasticity strain). A plurality of specimens to each of which given tensile strain c has been imparted in the range of 0% to 10% (0 to 0.10) are obtained in this manner. The tensile strain c before working (before impartment of tensile strain) is 0%.

Thereafter, for a central portion (hatched portion in FIG. 1) of each specimen, the amount of retained austenite when the tensile strain c is imparted is obtained in the above-described manner. The obtained results are plotted on a graph (horizontal axis: tensile strain c, vertical axis: logarithm of amount of retained austenite).

For the respective plots in the graphs (see FIGS. 3 to 5 to be described later), a first order approximation formula (y=−ax+b) is obtained using the least square method. The obtained approximation formula is applied to Formula (1) below, and the slope a of the approximation formula is obtained as the instability index k of retained austenite.

$$log ( f γ ) = - k \cdot ε + log ( f {γ}_{0} ) \qquad ( 1 )$$

In Formula (1) above, fγ represents the amount of retained austenite when the tensile strain c is imparted, and fγ₀ represents the amount of retained austenite before working.

Further, an estimate value of the amount of retained austenite before working (i.e., at the time when the tensile strain c is 0%) is obtained from the intercept of Formula (1) above. Then, the instability index d of retained austenite before working is obtained based on Formula (2) below.

$$d = f {γ}_{0} = f {γε}_{0} \qquad ( 2 )$$

In Formula (2) above, fγ₀ represents the actual measurement value of the amount of retained austenite before working, and fγε₀ represents the estimate value of retained austenite before working.

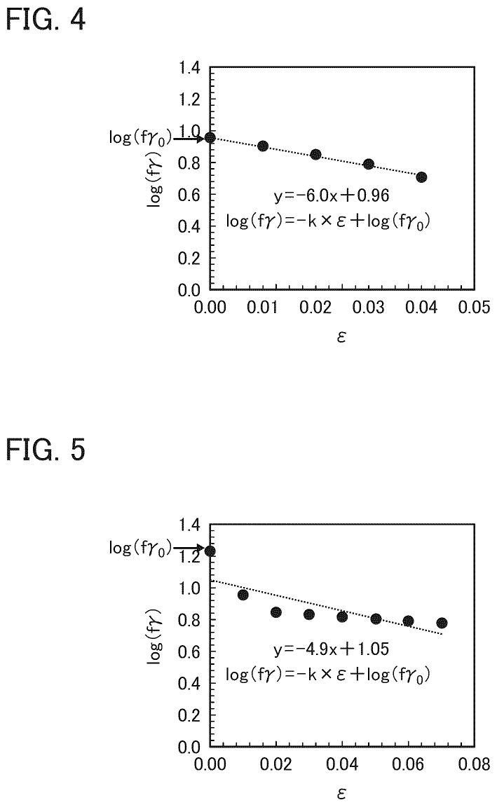

FIG. 3 is an exemplary graph showing the relation between the tensile strain c and the amount of retained austenite. FIG. 4 is another example of the graph. FIG. 5 is still another example of the graph.

Comparing FIGS. 3 and 4, the slope a (instability index k) of the approximation formula in FIG. 3 is 2.3 and is smaller than the slope a (instability index k) of the approximation formula in FIG. 4, that is, 6.0.

The slope a (instability index k) of the approximation formula being small indicates that the change in the amount of retained austenite is small during working, and the stability of retained austenite is good.

Referring to FIG. 5 next, the slope a (instability index k) of the approximation formula is as small as 4.9.

In FIG. 5, however, while the estimate value fγε₀ of retained austenite before working is 11.2 (log(fγε₀)=1.05), the actual measurement value fγ₀ of the amount of retained austenite before working is 18 (log(fγ₀)=1.26), and the instability index d (=fγ₀−fγε₀) is as large as 6.8.

When the instability index d is large, the slope of the approximation formula is large as far as an initial stage of working (initial stage of the tensile test) is concerned. That is, in this case, the stability of retained austenite is insufficient in the initial stage of working.

Hence, when both the instability index k and the instability index d satisfy the foregoing ranges, then retained austenite has excellent stability during working and also in the initial stage of working.

### <Plating Layer>

The present high strength steel sheet may further have a plating layer on a surface of the steel sheet for the purpose of improving corrosion resistance and other properties.

Examples of the plating layer include a galvanizing layer, a galvannealing layer, and an electrogalvanizing layer. The plating layer is formed by a plating treatment to be described later.

The coating weight of the plating layer is not particularly limited and is preferably 20 to 80 g/m² per one side.

### [Method for Manufacturing High Strength Steel Sheet]

Next, a method for manufacturing a high strength steel sheet according to the present embodiment (hereinafter also referred to as “present manufacturing method”) is described. The present manufacturing method is also a method for manufacturing the present high strength steel sheet described above.

The temperature at which a steel slab, the steel sheet, or the like is heated or cooled, which is described below, means a surface temperature of the steel slab, the steel sheet, or the like, unless otherwise specified.

A method of manufacturing molten steel which becomes a steel slab is not particularly limited, and known methods using a converter, an electric furnace, or the like are applicable. It is preferable to obtain a steel slab from molten steel by a continuous casting method for the sake of preventing macro-segregation.

### <Hot Rolling>

In the present manufacturing method, first, a steel slab having the present chemical composition described above is retained at a slab heating temperature described below and then hot-rolled to obtain a hot rolled steel sheet.

<<Slab Heating Temperature: Not Lower than 1220° C.>>

An excessively low slab heating temperature leads to insufficient dissolution of inclusions, and accordingly, the steel sheet embrittles, resulting in lower delayed fracture resistance. Hence, the slab heating temperature is preferably not lower than 1,220° C., more preferably not lower than 1,230° C., and even more preferably higher than 1,230° C.

While the upper limit is not particularly limited, the slab heating temperature is preferably not higher than 1,300° C., more preferably not higher than 1,290° C., and even more preferably not higher than 1,280° C.

### <Cooling>

The hot rolled steel sheet obtained through the hot rolling is cooled. In this process, an average cooling rate v₁ from 800° C. to 600° C. satisfies the range described below.

<<Average Cooling Rate v₁: Not Lower than 30° C./s>>

The present inventors found, through an earnest study, that the average cooling rate v₁ from 800° C. to 600° C. (also simply referred to as “average cooling rate v₁”) influences the instability index k of retained austenite.

When the average cooling rate v₁ is too low, coarse Nb-based carbides are excessively precipitated during cooling, and the effect of lowering the instability index k of retained austenite decreases due to Nb. This results in an increased instability index k and a narrower optimal clearance range.

Hence, the average cooling rate v₁ is not lower than 30° C./s, preferably not lower than 35° C./s, and more preferably not lower than 40° C./s.

### <Pickling and Cold Rolling>

Next, the hot rolled steel sheet thus cooled is subjected to pickling and cold rolling to obtain a cold rolled steel sheet.

Because pickling is capable of removing oxides on a surface of the hot rolled steel sheet, pickling is important to ensure good chemical convertibility and good plating quality of the final product, i.e., a high strength steel sheet. Pickling may be performed only once, or may be divided into plural steps.

The hot rolled steel sheet is subjected to pickling, thereby obtaining a pickled sheet. Subsequently, the pickled sheet is dried as appropriate.

Cold rolling may be performed on the pickled sheet before being dried or after being dried.

The rolling reduction in the cold rolling and the sheet thickness after the rolling are not particularly limited. The number of rolling passes and the rolling reduction for each pass are also not particularly limited.

Next, the cold rolled steel sheet obtained by the cold rolling is subjected to a heat treatment A, a heat treatment B, and a heat treatment C, as described below, in this order. The heat treatment C is preceded by working described below.

The details thereof are described below.

### <Heat Treatment A>

First, the cold rolled steel sheet obtained by the cold rolling is subjected to the heat treatment A.

In short, in the heat treatment A, the cold rolled steel sheet is retained (heated) at a temperature Ti described below and then cooled to a cooling stop temperature Ta described below.

The conditions for the heat treatment A are described below.

<<Temperature T1: Not Lower than 750° C. And not Higher than 900° C.>>

First, the cold rolled steel sheet is retained (heated) at the temperature T1. When the temperature T1 is too low, the amount of martensite decreases, and this makes it difficult to achieve a TS of not less than 980 MPa. Hence, the temperature T1 is not lower than 750° C., preferably not lower than 780° C., and more preferably not lower than 800° C.

Meanwhile, when the temperature T1 is too high, the total amount of ferrite and bainitic ferrite decreases, and this makes it difficult to achieve excellent ductility. Hence, the temperature T1 is not higher than 900° C., preferably not higher than 880° C., and more preferably not higher than 850° C.

### <<Retaining Time t₁: 10 Seconds or More and 1,000 Seconds or Less>>

When the time for retaining (heating) the cold rolled steel sheet at the temperature T1 (retaining time t₁) is too short, the amount of martensite decreases, and this makes it difficult to achieve a TS of not less than 980 MPa. Hence, the retaining time t₁ is 10 seconds or more, preferably 30 seconds or more, and more preferably 50 seconds or more.

Meanwhile, when the retaining time t₁ is too long, the total amount of ferrite and bainitic ferrite decreases, and this makes it difficult to achieve excellent ductility. Hence, the retaining time t₁ is 1,000 seconds or less, preferably 500 seconds or less, and more preferably 300 seconds or less.

<<Cooling Stop Temperature Ta: Not Lower than 100° C. And not Higher than (Ms Point−80° C.)>>

Next, the cold rolled steel sheet having been retained at the temperature T1 is cooled to the cooling stop temperature Ta.

When the cooling stop temperature Ta is too low, the amount of retained austenite decreases, resulting in lower ductility. Hence, the cooling stop temperature Ta is not lower than 100° C., preferably not lower than 120° C., and more preferably not lower than 140° C.

Meanwhile, when the cooling stop temperature Ta is too high, the amount of retained austenite excessively increases, and this leads to lower delayed fracture resistance. Hence, the cooling stop temperature Ta is not higher than (Ms point−80° C.), preferably not higher than (Ms point−90° C.), and more preferably not higher than (Ms point−100° C.).

When the cold rolled steel sheet is cooled from the temperature T1 to the cooling stop temperature Ta, the average cooling rates in temperature ranges described below are controlled to the ranges described below.

<<Average Cooling Rate v₂: Lower than 20° C./s>>

When an average cooling rate v₂ from 750° C. to 600° C. (also simply referred to as “average cooling rate v₂”) is too high, the total amount of ferrite and bainitic ferrite decreases, and this makes it difficult to achieve excellent ductility. Hence, the average cooling rate v₂ is lower than 20° C./s, preferably not higher than 19° C./s, and more preferably not higher than 17° C./s.

While the lower limit is not particularly limited, the average cooling rate v₂ is for instance not lower than 3° C./s, preferably not lower than 5° C./s, and more preferably not lower than 8° C./s.

<<Average Cooling Rate v₃: Not Higher than 150° C./s>>

The present inventors found, through an earnest study, that an average cooling rate v₃ from the Ms point to the cooling stop temperature Ta (also simply referred to as “average cooling rate v₃”) influences the instability index d of retained austenite in an initial stage of working.

When the average cooling rate v₃ is too high, retained austenite coarsens due to a high martensitic transformation rate, and the instability index d of retained austenite in an initial stage of working increases. This results in lower delayed fracture resistance and a narrower optimal clearance range. Hence, the average cooling rate v₃ is not higher than 150° C./s, preferably not higher than 120° C./s, and more preferably not higher than 90° C./s.

While the lower limit is not particularly limited, the average cooling rate v₃ is for instance not lower than 5° C./s, preferably not lower than 8° C./s, and more preferably not lower than 10° C./s.

<<Tension F: Not Less than 5 MPa and not More than 100 MPa

The present inventors found, through an earnest study, that a tension F imparted to the cold rolled steel sheet from the Ms point to the cooling stop temperature Ta (also simply referred to as “tension F”) influences the instability index d of retained austenite in an initial stage of working.

When the tension F is too small, martensite nucleation sites decrease, so that retained austenite coarsens, and the instability index d of retained austenite in an initial stage of working increases. This results in lower delayed fracture resistance and a narrower optimal clearance range. Hence, the tension F is not less than 5 MPa, preferably not less than 6 MPa, and more preferably not less than 8 MPa.

Meanwhile, when the tension F is too large, martensitic transformation excessively proceeds, so that the amount of retained austenite to be obtained decreases, and this makes it difficult to achieve excellent ductility. Hence, the tension F is not more than 100 MPa, preferably not more than 50 MPa, and more preferably not more than 25 MPa.

### <<Ms Point>>

The Ms point (unit: ° C.) is determined by Formula (a) below.

$$Ms = 519 - 474 \times [ \% C ] - 30.4 \times [ \% Mn ] - 12.1 \times [ \% Cr ] - 7.5 \times [ \% Mo ] - 17.7 \times [ \% Ni ] \qquad ( a )$$

In Formula (a) above, [% M] represents the content of an element M in the chemical composition, and when the element M is not contained, [% M] is 0.

### <Heat Treatment B>

Next, the cold rolled steel sheet having been cooled to the cooling stop temperature Ta is subjected to the heat treatment B.

In short, in the heat treatment B, the cold rolled steel sheet is retained (heated) at a temperature T2 described below and then cooled to a temperature (e.g., room temperature) lower than the temperature T2. The room temperature is 25° C., for instance.

The conditions for the heat treatment B are described below.

<<Temperature T2: Not Lower than Cooling Stop Temperature Ta and not Higher than 450° C.>>

First, the cold rolled steel sheet is retained (heated) at the temperature T2. This stabilizes retained austenite. When the temperature T2 is too low, a desired amount of retained austenite is not obtained, resulting in lower ductility. Hence, the temperature T2 is not lower than the cooling stop temperature Ta, preferably not lower than (Ta+10° C.), and more preferably not lower than (Ta+20° C.).

Meanwhile, when the temperature T2 is too high, tempering of martensite excessively proceeds, and this makes it difficult to achieve a TS of not less than 980 MPa. Hence, the temperature T2 is not higher than 450° C., preferably not higher than 420° C., and more preferably not higher than 400° C.

### <<Retaining Time T₂: 5 Seconds or More and 1,000 Seconds or Less>>

When the time for retaining the cold rolled steel sheet at the temperature T2 (retaining time t₂) is too short, stabilization of austenite is insufficient, and the instability index k of retained austenite increases, resulting in a narrower optimal clearance range. Hence, the retaining time t₂ is 5 seconds or more, preferably 50 seconds or more, and more preferably 80 seconds or more.

Meanwhile, when the retaining time t₂ is too long, tempering of martensite excessively proceeds, and this makes it difficult to achieve a TS of not less than 980 MPa. Hence, the retaining time t₂ is 1,000 seconds or less, preferably 800 seconds or less, and more preferably 400 seconds or less.

### <Working (Impartment of Equivalent Plastic Strain)>

The cold rolled steel sheet is wrought to impart equivalent plastic strain to the cold rolled steel sheet after the heat treatment A described above and before the heat treatment C described below.

The temperature during the working is not particularly limited. For instance, the working may be carried out while the cold rolled steel sheet is retained at the temperature T2 or after the cold rolled steel sheet is cooled to, for example, the room temperature subsequent to the retention at the temperature T2.

<<Equivalent Plastic Strain: Not Less than 0.10% and not More than 5.00%>>

The present inventors found, through an earnest study, that equivalent plastic strain imparted to the cold rolled steel sheet through the working (also simply referred to as “equivalent plastic strain”) influences the instability index d of retained austenite in an initial stage of working.

When the equivalent plastic strain is too small, unstable retained austenite that transforms in an initial stage of working increases, and accordingly, the instability index d increases, resulting in lower delayed fracture resistance and a narrower optimal clearance range. Hence, the equivalent plastic strain is not less than 0.10%, preferably not less than 0.15%, and more preferably not less than 0.30%.

Meanwhile, when the equivalent plastic strain is too large, work-induced transformation of retained austenite excessively proceeds, and the amount of retained austenite to be obtained decreases, resulting in lower ductility. Hence, the equivalent plastic strain is not more than 5.00%, preferably not more than 4.00%, and more preferably not more than 3.00%.

### <<Number of Times of Working>>

The number of times the cold rolled steel sheet is wrought is not particularly limited.

Specifically, the working may be divided into plural steps as long as the total equivalent plastic strain imparted to the cold rolled steel sheet through the whole working is within the foregoing range.

For instance, even when the equivalent plastic strain imparted to the cold rolled steel sheet in the first working is less than the foregoing lower limit value, it suffices if the total equivalent plastic strain obtained after the second and subsequent working is not less than the foregoing lower limit value (not more than the foregoing lower limit value).

### <<Working Method>>

Examples of the method of working the cold rolled steel sheet include: a method in which the cold rolled steel sheet is subjected to temper rolling; and a method in which the cold rolled steel sheet is wrought using a tension leveler. Examples of the leveler include a tension leveler, a continuous stretcher leveler, and a roller leveler, and a tension leveler is favorable.

When temper rolling is performed, the equivalent plastic strain is an elongation rate of the steel sheet (cold rolled steel sheet) and is determined from the change in length of the steel sheet before and after working.

When the cold rolled steel sheet is wrought using a tension leveler, the equivalent plastic strain is calculated according to the method described in Reference Literature 1 below. For the calculation, the following data input values are used, a material is assumed to be an elasto-plastic body whose work hardening behavior is linear curing, Bauschinger curing is ignored, and a decrease in tension due to bend loss is ignored. For the working curvature formula, Misaka's formula is used.
Number of dividing sheet thickness: 31
Young's modulus: 21,000 kgf/mm²
Poisson's ratio: 0.3
Yield stress: 111 kgf/mm²
Plasticity coefficient: 1,757 kgf/mm²
Reference Literature 1: Yoshisuke MISAKA, Takeshi MASUI, Sosei to kakou [plasticity and working], 1976, vol. 17, pp. 988-994

### <Heat Treatment C>

Next, the cold rolled steel sheet having been cooled to, for example, the room temperature is subjected to the heat treatment C.

In short, in the heat treatment C, the cold rolled steel sheet is heated to a temperature T3 described below and then cooled to a temperature (e.g., room temperature) lower than the temperature T3 without being retained at the temperature T3.

<<Temperature T3: Not Lower than 150° C. And not Higher than 400° C.>>

When the temperature T3 is too low, stabilization of austenite is insufficient, and the instability index k of retained austenite increases, resulting in a narrower optimal clearance range. Hence, the temperature T3 is not lower than 150° C., preferably not lower than 160° C., and more preferably not lower than 170° C.

Meanwhile, when the temperature T3 is too high, tempering of martensite excessively proceeds, and this makes it difficult to achieve a TS of not less than 980 MPa. Hence, the temperature T3 is not higher than 400° C., preferably not higher than 350° C., and more preferably not higher than 300° C.

### (No Retention at Temperature T3)

If the cold rolled steel sheet is retained at the temperature T3, precipitation of carbides is promoted, so that carbon contributing to stabilization of austenite is consumed. This makes stabilization of austenite insufficient, and the instability index k of retained austenite increases, resulting in a narrower optimal clearance range.

Hence, the cold rolled steel sheet having been heated to the temperature T3 is immediately cooled without being retained at the temperature T3 as described above.

When the cold rolled steel sheet is cooled from the temperature T3 to, for example, the room temperature, the average cooling rate in the temperature range described below is controlled to the range described below.

<<Average Cooling Rate v₄: Not Lower than 1.0° C./h and not Higher than 50.0° C./h>>

When an average cooling rate v₄ from 150° C. to 50° C. (also simply referred to as “average cooling rate v₄”) is too high, concentrating of carbon into austenite during cooling is insufficient. This makes stabilization of austenite insufficient, and the instability index k of retained austenite increases, resulting in a narrower optimal clearance range. Hence, the average cooling rate v₄ is not higher than 50.0° C./h, preferably not higher than 48.0° C./h, and more preferably not higher than 45.0° C./h.

Meanwhile, the average cooling rate v₄ is not lower than 1.0° C./h, preferably not lower than 1.2° C./h, and more preferably not lower than 1.4° C./h due to production engineering constraints.

The cold rolled steel sheet having undergone the heat treatment C corresponds to the steel sheet included in the present high strength steel sheet described above.

After the heat treatment C, the cold rolled steel sheet may be wrought to again impart an equivalent plastic strain of not less than 0.10% and not more than 5.00%. After the working, the cold rolled steel sheet may be heated at a temperature of not lower than 100° C. and not higher than 400° C.

### <Plating Treatment>

The cold rolled steel sheet may be subjected to a plating treatment. A plating layer is thereby formed.

The plating treatment is performed, for instance, during or after the heat treatment A described above.

In the case of performing the plating treatment during the heat treatment A, a galvanizing treatment or a galvannealing treatment (treatment in which alloying is performed after galvanizing treatment) is performed while (or after) the cold rolled steel sheet is cooled from 750° C. to 600° C. at the average cooling rate v₂, for example.

In the case of performing the plating treatment after the heat treatment A, an electrogalvanizing treatment is performed after the heat treatment B, for example. Examples of the electrogalvanizing treatment include a Zn—Ni electric alloy plating treatment, and a pure Zn electroplating treatment.

It should be noted that the plating treatment is not limited to the aforementioned galvanizing treatment, galvannealing treatment, or electrogalvanizing treatment. The metal species used in the plating treatment is not limited to Zn and may be other metals (e.g., Al).

The coating weight of the plating layer to be formed can be adjusted by performing wiping during the plating treatment.

Other conditions for the plating treatment are not particularly limited, and the plating treatment can be carried out according to an ordinary method.

A series of treatments including the heat treatments A to C and the plating treatment as described above is preferably carried out in a continuous galvanizing line (CGL) for the sake of productivity.

### EXAMPLES

Aspects of the invention are specifically described below by way of examples. However, the invention is not limited to the examples described below.

### <Manufacture of Steel Sheet>

Molten steel having a chemical composition as shown in Table 1 below with the balance being Fe and inevitable impurities was made in a converter, and a steel slab was obtained by a continuous casting method. In Table 1 below, the underlined figures mean those out of the ranges of the invention (the same applies to Tables 2 and 3 to be described later).

The obtained steel slab was retained at a slab heating temperature as shown in Table 2 below and then hot rolled to obtain a hot rolled steel sheet. The hot rolled steel sheet obtained was cooled. In this process, the hot rolled steel sheet was cooled from 800° C. to 600° C. at the average cooling rate v₁ as shown in Table 2 below.

The hot rolled steel sheet thus cooled was pickled and then cold rolled to obtain a cold rolled steel sheet.

The cold rolled steel sheet obtained was subjected to the heat treatments A to C under the conditions shown in Table 2 below. Before the heat treatment C, the cold rolled steel sheet was wrought under the conditions shown in Table 2 below.

In this manner, the cold rolled steel sheet with the final sheet thickness shown in Table 2 below was obtained.

In some examples, the cold rolled steel sheet (CR) was subjected to a plating treatment (galvanizing treatment, galvannealing treatment, or electrogalvanizing treatment) to obtain a galvanized steel sheet (GI), a galvannealed steel sheet (GA), or an electrogalvanized steel sheet (EG).

The galvanizing treatment and the galvannealing treatment were each performed during cooling in the heat treatment A. The electrogalvanizing treatment was performed after the heat treatment B (before the heat treatment C).

As a galvanizing bath, when GI was manufactured, a zinc bath containing 0.20 mass % of Al with the balance being Zn and inevitable impurities was used, and when GA was manufactured, a zinc bath containing 0.14 mass % of Al with the balance being Zn and inevitable impurities was used.

The bath temperature was set to 470° C. for both cases of manufacturing GI and GA.

The coating weight of the plating layer was 45 to 72 g/m² per one side when GI was manufactured and 45 g/m² per one side when GA was manufactured.

When GA was manufactured, the alloying temperature was set to 500° C.

The composition of the plating layer of GI was the composition including 0.1 to 1.0 mass % of Fe and 0.2 to 1.0 mass % of Al with the balance being Zn and inevitable impurities. The composition of the plating layer of GA was the composition including 7 to 15 mass % of Fe and 0.1 to 1.0 mass % of Al with the balance being Zn and inevitable impurities.

When EG was manufactured, the electrogalvanizing treatment was performed such that the plating layer had a coating weight of 30 g/m² per one side.

Hereinbelow, each of the cold rolled steel sheet (CR), the galvanized steel sheet (GI), the galvannealed steel sheet (GA), and the electrogalvanized steel sheet (EG) is also simply referred to as “steel sheet.”

### <Observation of Microstructure>

With respect to each of the obtained steel sheets, the amount of martensite, the amount of retained austenite, and the total amount of ferrite and bainitic ferrite were obtained by the foregoing methods. The results are shown in Table 3 below. In Table 3 below, martensite is denoted as “M,” austenite “γ,” ferrite “F,” and bainitic ferrite “BF.”

<Instability Index k and Instability Index d>

With respect to each of the obtained steel sheets, the instability index k of retained austenite and the instability index d of retained austenite in an initial stage of working were obtained by the foregoing methods. The results are shown in Table 3 below.

### <Evaluation>

With respect to each of the obtained steel sheets, various properties were evaluated through the tests described below. The results are shown in Table 3 below.

### <<Tensile Strength and Elongation (Tensile Test)>>

From each of the obtained steel sheets, a JIS No. 5 specimen (gauge length: 50 mm; parallel width: 25 mm) with its longitudinal direction (tensile direction) being perpendicular to the rolling direction was sampled. Using the specimen thus sampled, a tensile test was performed in accordance with JIS Z 2241 under the condition of a crosshead speed of 1.67×10⁻¹ mm/s; thus, the tensile strength (TS) and the elongation (El) were determined.

The strength was determined to be high when the TS was not less than 980 MPa.

When the El was not less than 8%, the ductility was determined to be excellent.

### <<Delayed Fracture Resistance>>

From each of the obtained steel sheets, a specimen (parallel width: 6 mm; parallel length: 15 mm) with its width direction being parallel to the rolling direction was sampled. The entire surface of the specimen was ground to a sheet thickness of 1.0 mm, and then a test was performed.

The specimen was immersed in an aqueous solution containing 3 mass % of NaCl and 3 g/L of NH₄SCN and retained for 24 hours with an applied current density of 0 or 0.05 mA/cm². Thereafter, a tensile test (SSRT test) was performed at a tensile rate of 5 μm/min to break the specimen, thus determining the tensile strength (TS).

The ratio of the TS when the applied current density was 0.05 mA/cm² to the TS when the applied current density was 0 mA/cm² was obtained as a stress ratio.

In Table 3 below, “C” was provided when the stress ratio was less than 0.70, “B” was provided when it was not less than 0.70 and less than 0.80, and “A” was provided when it was not less than 0.80. In the case of “B” or “A,” the delayed fracture resistance was determined to be excellent.

### <<Bending Test>>

From each of the obtained steel sheets, a specimen (width: 30 mm; length: 100 mm) with its longitudinal direction being perpendicular to the rolling direction was sampled. Using the specimen thus sampled, a bending test was performed in accordance with a V-block method stated in JIS Z 2248 to measure a minimum bending radius R with which cracking did not occur at a bent ridge portion.

Occurrence or non-occurrence of cracking was checked by observing the bent ridge portion with a digital microscope (RH-2000, manufactured by HIROX Co., Ltd.) at a magnification of 40×.

### <<Optimal Clearance Range>>

The optimal clearance range with respect to bending forming of a shear end surface was determined as follows.

First, each of the obtained steel sheets was sheared to sample a specimen (width: 30 mm; length: 100 mm) with its longitudinal direction being perpendicular to the rolling direction. The rake angle in shearing was set to 0° in all examples, and the shear clearance was varied to 5%, 10%, 15%, 20%, 25%, 30%, and 35%.

With the specimen obtained through the shearing, a bending test was carried out in accordance with the method described above by use of a punch with which a value obtained by dividing the minimum bending radius R by the sheet thickness t (R/t) became 6.0. Thus, a shear end surface of the specimen was subjected to bending forming (bending). Thereafter, the shear end surface of the specimen was checked for occurrence or non-occurrence of cracking.

Occurrence or non-occurrence of cracking was checked by observing the shear end surface of the specimen with a digital microscope (RH-2000, manufactured by HIROX Co., Ltd.) at a magnification of 40×.

In Table 3 below, “C” was provided when the shear clearance range with which no cracking occurred in the shear end surface of the specimen was less than 10%, “B” was provided when it was not less than 10% and less than 15%, and “A” was provided when it was not less than 15%. In the case of “B” or “A,” the optimal clearance range with respect to bending forming of a shear end surface was determined to be wide.

TABLE 1

| Type | | | | | | | | | | | | | | |
|---|---|---|---|---|---|---|---|---|---|---|---|---|---|---|
| of | Chemical composition [mass %] | | | | | | | | | | | | | |
| Steel | C | Si | Mn | P | S | N | O | Al | Nb | Ti | B | Cu | Others | Remarks |
| A | 0.216 | 1.37 | 2.78 | 0.010 | 0.0006 | 0.0070 | 0.0020 | 0.057 | 0.020 | | | | | IE |
| B | 0.223 | 1.21 | 2.67 | 0.008 | 0.0013 | 0.0010 | 0.0040 | 0.012 | 0.018 | | | | | IE |
| C | 0.217 | 1.31 | 2.74 | 0.012 | 0.0008 | 0.0020 | 0.0060 | 0.025 | 0.019 | | | | | IE |
| D | 0.247 | 1.39 | 2.86 | 0.008 | 0.0006 | 0.0050 | 0.0020 | 0.046 | 0.021 | | | | | IE |
| E | 0.221 | 1.21 | 2.70 | 0.014 | 0.0006 | 0.0010 | 0.0020 | 0.018 | 0.020 | | | | | IE |
| F | 0.035 | 1.01 | 2.94 | 0.011 | 0.0009 | 0.0010 | 0.0010 | 0.045 | 0.021 | | | | | IE |
| G | 0.025 | 1.35 | 2.83 | 0.006 | 0.0015 | 0.0050 | 0.0040 | 0.052 | 0.019 | | | | | CE |
| H | 0.464 | 1.35 | 2.87 | 0.010 | 0.0013 | 0.0020 | 0.0040 | 0.057 | 0.020 | | | | | IE |
| I | 0.519 | 1.39 | 2.72 | 0.011 | 0.0009 | 0.0030 | 0.0020 | 0.045 | 0.019 | | | | | CE |
| J | 0.242 | 0.69 | 2.81 | 0.011 | 0.0014 | 0.0050 | 0.0020 | 0.052 | 0.017 | | | | | IE |
| K | 0.232 | 0.41 | 2.94 | 0.012 | 0.0014 | 0.0020 | 0.0060 | 0.059 | 0.017 | | | | | CE |
| L | 0.220 | 2.47 | 2.83 | 0.012 | 0.0010 | 0.0010 | 0.0050 | 0.027 | 0.016 | | | | | IE |
| M | 0.218 | 2.57 | 3.00 | 0.006 | 0.0009 | 0.0030 | 0.0070 | 0.024 | 0.019 | | | | | CE |
| N | 0.243 | 1.33 | 1.85 | 0.012 | 0.0011 | 0.0060 | 0.0020 | 0.059 | 0.021 | | | | | IE |
| O | 0.225 | 1.10 | 1.38 | 0.005 | 0.0009 | 0.0060 | 0.0050 | 0.016 | 0.016 | | | | | CE |
| P | 0.216 | 1.00 | 4.66 | 0.013 | 0.0013 | 0.0070 | 0.0020 | 0.016 | 0.018 | | | | | IE |
| Q | 0.220 | 1.27 | 5.12 | 0.007 | 0.0014 | 0.0010 | 0.0070 | 0.023 | 0.021 | | | | | CE |
| R | 0.231 | 1.08 | 2.95 | 0.097 | 0.0007 | 0.0060 | 0.0040 | 0.048 | 0.020 | | | | | IE |
| S | 0.214 | 1.17 | 2.97 | 0.115 | 0.0013 | 0.0050 | 0.0060 | 0.024 | 0.019 | | | | | CE |
| T | 0.212 | 1.03 | 2.67 | 0.008 | 0.0195 | 0.0060 | 0.0050 | 0.050 | 0.019 | | | | | IE |
| U | 0.216 | 1.28 | 2.73 | 0.012 | 0.0215 | 0.0060 | 0.0020 | 0.032 | 0.021 | | | | | CE |
| V | 0.217 | 1.10 | 2.98 | 0.008 | 0.0013 | 0.0060 | 0.0020 | 0.924 | 0.020 | | | | | IE |
| W | 0.216 | 1.23 | 2.94 | 0.007 | 0.0013 | 0.0060 | 0.0040 | 1.054 | 0.020 | | | | | CE |
| X | 0.247 | 1.38 | 2.85 | 0.007 | 0.0015 | 0.0090 | 0.0060 | 0.053 | 0.021 | | | | | IE |
| Y | 0.235 | 1.10 | 2.73 | 0.007 | 0.0006 | 0.0120 | 0.0060 | 0.012 | 0.016 | | | | | CE |
| Z | 0.250 | 1.22 | 2.97 | 0.014 | 0.0006 | 0.0050 | 0.0090 | 0.023 | 0.018 | | | | | IE |
| AA | 0.239 | 1.10 | 2.81 | 0.009 | 0.0007 | 0.0040 | 0.0110 | 0.054 | 0.019 | | | | | CE |
| AB | 0.221 | 1.02 | 2.96 | 0.015 | 0.0010 | 0.0020 | 0.0060 | 0.058 | 0.008 | | | | | IE |
| AC | 0.216 | 1.31 | 2.68 | 0.010 | 0.0010 | 0.0010 | 0.0020 | 0.027 | 0.003 | | | | | CE |
| AD | 0.238 | 1.14 | 2.86 | 0.009 | 0.0005 | 0.0060 | 0.0020 | 0.013 | 0.080 | | | | | IE |
| AE | 0.226 | 1.31 | 2.91 | 0.014 | 0.0010 | 0.0010 | 0.0030 | 0.016 | 0.114 | | | | | CE |
| AF | 0.246 | 1.23 | 2.88 | 0.015 | 0.0006 | 0.0020 | 0.0050 | 0.035 | 0.020 | 0.042 | | | | IE |
| AG | 0.236 | 1.15 | 2.70 | 0.012 | 0.0010 | 0.0050 | 0.0050 | 0.036 | 0.022 | 0.189 | | | | IE |
| AH | 0.238 | 1.07 | 2.81 | 0.013 | 0.0015 | 0.0020 | 0.0040 | 0.019 | 0.020 | 0.215 | | | | CE |
| AI | 0.211 | 1.13 | 2.76 | 0.008 | 0.0014 | 0.0070 | 0.0060 | 0.046 | 0.021 | | 0.0021 | | | IE |
| AJ | 0.211 | 1.23 | 2.72 | 0.011 | 0.0012 | 0.0050 | 0.0010 | 0.052 | 0.020 | | 0.0072 | | | IE |
| AK | 0.216 | 1.30 | 2.91 | 0.015 | 0.0013 | 0.0030 | 0.0040 | 0.039 | 0.016 | | 0.0104 | | | CE |
| AL | 0.229 | 1.05 | 2.73 | 0.012 | 0.0011 | 0.0020 | 0.0030 | 0.044 | 0.019 | | | 0.15 | | IE |
| AM | 0.221 | 1.06 | 2.80 | 0.009 | 0.0007 | 0.0040 | 0.0010 | 0.018 | 0.016 | | | 0.96 | | IE |
| AN | 0.238 | 1.23 | 2.99 | 0.015 | 0.0008 | 0.0060 | 0.0050 | 0.017 | 0.019 | | | 1.11 | | CE |
| AO | 0.232 | 1.37 | 2.60 | 0.006 | 0.0008 | 0.0030 | 0.0020 | 0.030 | 0.021 | | | | V: 0.157 | IE |
| AP | 0.242 | 1.16 | 2.69 | 0.014 | 0.0008 | 0.0060 | 0.0060 | 0.033 | 0.019 | | | | Ta: 0.09 | IE |
| AQ | 0.242 | 1.06 | 2.75 | 0.013 | 0.0013 | 0.0010 | 0.0030 | 0.055 | 0.021 | | | | W: 0.09 | IE |
| AR | 0.222 | 1.30 | 3.00 | 0.005 | 0.0012 | 0.0010 | 0.0060 | 0.045 | 0.022 | | | | Cr: 0.73 | IE |
| AS | 0.231 | 1.37 | 2.86 | 0.011 | 0.0013 | 0.0060 | 0.0060 | 0.033 | 0.018 | | | | Mo: 0.36 | IE |
| AT | 0.218 | 1.32 | 3.00 | 0.010 | 0.0015 | 0.0070 | 0.0060 | 0.012 | 0.015 | | | | Co: 0.009 | IE |
| AU | 0.218 | 1.26 | 2.70 | 0.006 | 0.0011 | 0.0070 | 0.0020 | 0.016 | 0.021 | | | | Ni: 0.33 | IE |
| AV | 0.249 | 1.08 | 2.93 | 0.010 | 0.0012 | 0.0030 | 0.0050 | 0.015 | 0.015 | | | | Sn: 0.055 | IE |
| AW | 0.246 | 1.06 | 2.61 | 0.013 | 0.0006 | 0.0050 | 0.0050 | 0.043 | 0.020 | | | | Sb: 0.120 | IE |
| AX | 0.216 | 1.19 | 2.84 | 0.012 | 0.0010 | 0.0050 | 0.0070 | 0.047 | 0.019 | | | | Ca: 0.0067 | IE |
| AY | 0.246 | 1.28 | 2.89 | 0.011 | 0.0013 | 0.0040 | 0.0060 | 0.050 | 0.020 | | | | Mg: 0.0090 | IE |
| AZ | 0.241 | 1.07 | 2.97 | 0.005 | 0.0006 | 0.0070 | 0.0020 | 0.027 | 0.015 | | | | Zr: 0.076 | IE |
| BA | 0.240 | 1.40 | 2.72 | 0.009 | 0.0006 | 0.0050 | 0.0020 | 0.031 | 0.018 | | | | Te: 0.012 | IE |
| BB | 0.244 | 1.31 | 2.94 | 0.006 | 0.0014 | 0.0040 | 0.0070 | 0.044 | 0.018 | | | | Hf: 0.01 | IE |
| BC | 0.234 | 1.05 | 2.61 | 0.007 | 0.0008 | 0.0030 | 0.0050 | 0.048 | 0.018 | | | | REM: 0.0065 | IE |
| BD | 0.215 | 1.10 | 2.91 | 0.009 | 0.0015 | 0.0040 | 0.0050 | 0.060 | 0.021 | | | | Bi: 0.085 | IE |
| BE | 0.245 | 1.29 | 2.74 | 0.008 | 0.0006 | 0.0020 | 0.0030 | 0.020 | 0.017 | | | | | IE |
| BF | 0.213 | 1.13 | 2.88 | 0.012 | 0.0005 | 0.0040 | 0.0020 | 0.045 | 0.017 | | | | | IE |
| BG | 0.215 | 1.07 | 2.85 | 0.005 | 0.0007 | 0.0030 | 0.0040 | 0.048 | 0.021 | | | | | IE |
| BH | 0.218 | 1.25 | 2.66 | 0.009 | 0.0012 | 0.0020 | 0.0070 | 0.022 | 0.016 | | | | | IE |
| BI | 0.219 | 1.12 | 2.89 | 0.007 | 0.0010 | 0.0020 | 0.0020 | 0.012 | 0.020 | | | | | IE |

IE: Inventive Example
CE: Comparative Example

TABLE 2

| | | Hot | | Heat treatment A | | | | | | |
|---|---|---|---|---|---|---|---|---|---|---|
| | | rolling | Cooling | | | | | | | Cooling |
| | | Slab | Average | | Retaining | Average | Average | | | stop |
| | Type | heating | cooling | Temp. | time | cooling | cooling | Tension | Ms | temp. |
| | of | temp. | rate v₁ | T1 | t₁ | rate v₂ | rate v₃ | F | point | Ta |
| No. | steel | [° C.] | [° C./s] | [° C.] | [s] | [° C./s] | [° C./s] | [MPa] | [° C.] | [° C.] |
| 1 | A | 1249 | 58 | 824 | 98 | 11 | 18 | 14 | 329 | 204 |
| 2 | B | 1253 | 44 | 827 | 199 | 11 | 18 | 12 | 315 | 194 |
| 3 | B | 1253 | 56 | 816 | 166 | 12 | 14 | 13 | 315 | 196 |
| 4 | B | 1228 | 49 | 813 | 187 | 12 | 13 | 11 | 315 | 212 |
| 5 | B | 1223 | 52 | 827 | 183 | 12 | 11 | 16 | 315 | 202 |
| 6 | B | 1257 | 54 | 830 | 65 | 15 | 20 | 15 | 315 | 213 |
| 7 | B | 1234 | 43 | 819 | 94 | 11 | 20 | 10 | 315 | 191 |
| 8 | B | 1249 | 34 | 824 | 96 | 13 | 15 | 15 | 315 | 196 |
| 9 | B | 1250 | 15 | 823 | 169 | 13 | 14 | 15 | 315 | 202 |
| 10 | B | 1232 | 44 | 822 | 133 | 10 | 109 | 9 | 315 | 206 |
| 11 | B | 1260 | 51 | 823 | 145 | 12 | 108 | 15 | 315 | 194 |
| 12 | B | 1240 | 43 | 754 | 80 | 12 | 18 | 16 | 315 | 203 |
| 13 | B | 1236 | 60 | 741 | 126 | 12 | 14 | 17 | 315 | 194 |
| 14 | B | 1234 | 56 | 890 | 200 | 11 | 17 | 15 | 315 | 210 |
| 15 | B | 1257 | 58 | 912 | 166 | 12 | 12 | 17 | 315 | 191 |
| 16 | B | 1260 | 51 | 818 | 31 | 13 | 16 | 17 | 315 | 186 |
| 17 | B | 1237 | 56 | 813 | 5 | 14 | 14 | 15 | 315 | 214 |
| 18 | B | 1250 | 45 | 827 | 998 | 13 | 10 | 11 | 315 | 205 |
| 19 | B | 1248 | 52 | 827 | 1015 | 15 | 19 | 17 | 315 | 193 |
| 20 | B | 1247 | 51 | 818 | 123 | 19 | 11 | 14 | 315 | 206 |
| 21 | B | 1248 | 59 | 830 | 59 | 22 | 17 | 17 | 315 | 206 |
| 22 | B | 1254 | 56 | 818 | 161 | 11 | 138 | 16 | 315 | 214 |
| 23 | B | 1230 | 46 | 820 | 79 | 14 | 158 | 9 | 315 | 191 |
| 24 | B | 1241 | 51 | 824 | 71 | 10 | 13 | 14 | 315 | 106 |
| 25 | B | 1260 | 53 | 813 | 135 | 10 | 18 | 9 | 315 | 97 |
| 26 | B | 1240 | 53 | 829 | 74 | 12 | 10 | 17 | 315 | 235 |
| 27 | B | 1257 | 57 | 819 | 117 | 12 | 16 | 10 | 315 | 243 |
| 28 | B | 1246 | 58 | 829 | 104 | 15 | 12 | 9 | 315 | 187 |
| 29 | B | 1235 | 46 | 819 | 161 | 12 | 19 | 14 | 315 | 211 |
| 30 | B | 1249 | 47 | 823 | 74 | 11 | 15 | 13 | 315 | 188 |
| 31 | B | 1256 | 41 | 826 | 80 | 12 | 18 | 17 | 315 | 213 |
| 32 | B | 1259 | 52 | 812 | 194 | 13 | 13 | 12 | 315 | 194 |
| 33 | B | 1259 | 57 | 822 | 128 | 12 | 16 | 18 | 315 | 208 |
| 34 | B | 1246 | 41 | 826 | 58 | 14 | 20 | 17 | 315 | 190 |
| 35 | B | 1256 | 40 | 811 | 137 | 13 | 13 | 12 | 315 | 201 |
| 36 | B | 1234 | 43 | 822 | 178 | 12 | 10 | 10 | 315 | 192 |
| 37 | B | 1242 | 58 | 818 | 85 | 14 | 11 | 15 | 315 | 186 |
| 38 | B | 1241 | 60 | 812 | 186 | 11 | 17 | 11 | 315 | 209 |
| 39 | B | 1249 | 50 | 822 | 74 | 13 | 14 | 13 | 315 | 203 |
| 40 | B | 1251 | 45 | 829 | 130 | 13 | 16 | 6 | 315 | 193 |
| 41 | B | 1248 | 43 | 814 | 92 | 12 | 16 | 3 | 315 | 214 |
| 42 | B | 1260 | 56 | 826 | 81 | 15 | 14 | 83 | 315 | 196 |
| 43 | B | 1232 | 53 | 821 | 182 | 11 | 15 | 115 | 315 | 210 |
| 44 | B | 1251 | 52 | 826 | 138 | 15 | 15 | 11 | 315 | 213 |
| 45 | B | 1247 | 44 | 825 | 165 | 13 | 15 | 17 | 315 | 197 |
| 46 | B | 1234 | 49 | 815 | 110 | 13 | 19 | 13 | 315 | 206 |
| 47 | B | 1241 | 50 | 828 | 111 | 14 | 12 | 13 | 315 | 190 |
| 48 | B | 1240 | 41 | 813 | 87 | 12 | 13 | 13 | 315 | 205 |
| 49 | B | 1239 | 58 | 815 | 156 | 14 | 18 | 15 | 315 | 208 |
| 50 | B | 1240 | 40 | 822 | 192 | 11 | 10 | 18 | 315 | 204 |
| 51 | B | 1235 | 46 | 815 | 194 | 14 | 19 | 14 | 315 | 189 |
| 52 | B | 1235 | 58 | 817 | 82 | 10 | 13 | 13 | 315 | 198 |
| 53 | B | 1258 | 60 | 820 | 165 | 13 | 18 | 15 | 315 | 195 |
| 54 | B | 1247 | 57 | 821 | 65 | 12 | 17 | 8 | 315 | 191 |
| 55 | C | 1260 | 51 | 827 | 70 | 12 | 17 | 12 | 329 | 206 |
| 56 | D | 1236 | 58 | 827 | 171 | 14 | 18 | 13 | 325 | 199 |
| 57 | E | 1254 | 42 | 821 | 180 | 14 | 10 | 13 | 321 | 201 |
| 58 | F | 1251 | 52 | 816 | 171 | 12 | 15 | 17 | 410 | 294 |
| 59 | G | 1233 | 53 | 815 | 136 | 14 | 11 | 16 | 418 | 290 |
| 60 | H | 1258 | 41 | 813 | 117 | 15 | 19 | 13 | 206 | 77 |
| 61 | I | 1235 | 60 | 817 | 149 | 10 | 14 | 11 | 192 | 87 |
| 62 | J | 1235 | 42 | 818 | 91 | 15 | 13 | 13 | 322 | 220 |
| 63 | K | 1251 | 51 | 816 | 196 | 11 | 13 | 10 | 334 | 206 |
| 64 | L | 1252 | 51 | 813 | 178 | 11 | 15 | 12 | 332 | 207 |
| 65 | M | 1241 | 56 | 813 | 174 | 13 | 15 | 12 | 326 | 215 |
| 66 | N | 1231 | 49 | 811 | 122 | 12 | 18 | 11 | 398 | 287 |
| 67 | O | 1242 | 50 | 818 | 99 | 12 | 10 | 9 | 406 | 297 |
| 68 | P | 1258 | 44 | 815 | 95 | 13 | 15 | 15 | 272 | 153 |
| 69 | Q | 1250 | 53 | 812 | 56 | 15 | 14 | 13 | 251 | 150 |
| 70 | R | 1244 | 58 | 827 | 103 | 13 | 14 | 15 | 315 | 215 |
| 71 | S | 1245 | 49 | 830 | 106 | 14 | 16 | 13 | 326 | 214 |
| 72 | T | 1244 | 52 | 814 | 92 | 12 | 10 | 17 | 317 | 207 |
| 73 | U | 1234 | 56 | 824 | 168 | 12 | 17 | 16 | 331 | 221 |
| 74 | V | 1245 | 44 | 814 | 97 | 13 | 14 | 11 | 319 | 201 |
| 75 | W | 1240 | 50 | 823 | 104 | 14 | 14 | 9 | 335 | 214 |
| 76 | X | 1257 | 42 | 814 | 181 | 10 | 12 | 18 | 328 | 218 |
| 77 | Y | 1245 | 59 | 824 | 122 | 14 | 12 | 17 | 321 | 203 |
| 78 | Z | 1236 | 55 | 829 | 158 | 10 | 17 | 15 | 335 | 233 |
| 79 | AA | 1256 | 56 | 821 | 190 | 13 | 14 | 17 | 331 | 219 |
| 80 | AB | 1242 | 58 | 812 | 152 | 11 | 11 | 13 | 330 | 212 |
| 81 | AC | 1247 | 58 | 811 | 136 | 11 | 17 | 9 | 327 | 210 |
| 82 | AD | 1248 | 60 | 828 | 62 | 12 | 15 | 10 | 332 | 221 |
| 83 | AE | 1245 | 44 | 825 | 175 | 12 | 14 | 17 | 335 | 212 |
| 84 | AF | 1232 | 46 | 815 | 119 | 13 | 19 | 12 | 337 | 221 |
| 85 | AG | 1249 | 46 | 824 | 62 | 15 | 15 | 13 | 329 | 202 |
| 86 | AH | 1230 | 58 | 822 | 67 | 11 | 10 | 13 | 327 | 205 |
| 87 | AI | 1243 | 50 | 814 | 67 | 11 | 13 | 9 | 334 | 207 |
| 88 | AJ | 1241 | 50 | 821 | 110 | 12 | 19 | 13 | 327 | 202 |
| 89 | AK | 1230 | 56 | 827 | 57 | 10 | 13 | 17 | 319 | 214 |
| 90 | AL | 1240 | 43 | 826 | 91 | 14 | 19 | 16 | 324 | 212 |
| 91 | AM | 1245 | 56 | 823 | 147 | 12 | 11 | 10 | 318 | 205 |
| 92 | AN | 1233 | 55 | 824 | 180 | 13 | 13 | 15 | 335 | 228 |
| 93 | AO | 1228 | 45 | 821 | 124 | 15 | 19 | 15 | 331 | 222 |
| 94 | AP | 1251 | 35 | 823 | 127 | 13 | 13 | 17 | 330 | 205 |
| 95 | AQ | 1259 | 50 | 766 | 169 | 14 | 11 | 12 | 329 | 212 |
| 96 | AR | 1259 | 55 | 827 | 31 | 15 | 12 | 11 | 312 | 186 |
| 97 | AS | 1231 | 51 | 826 | 102 | 19 | 17 | 17 | 316 | 209 |
| 98 | AT | 1242 | 41 | 815 | 71 | 15 | 148 | 15 | 329 | 211 |
| 99 | AU | 1255 | 46 | 817 | 99 | 11 | 16 | 10 | 318 | 107 |
| 100 | AV | 1238 | 46 | 812 | 69 | 10 | 10 | 10 | 320 | 233 |
| 101 | AW | 1253 | 41 | 827 | 149 | 10 | 19 | 9 | 320 | 194 |
| 102 | AX | 1249 | 50 | 818 | 142 | 10 | 13 | 10 | 323 | 221 |
| 103 | AY | 1242 | 52 | 815 | 137 | 11 | 12 | 12 | 320 | 205 |
| 104 | AZ | 1247 | 58 | 816 | 181 | 10 | 15 | 16 | 314 | 191 |
| 105 | BA | 1245 | 42 | 816 | 63 | 14 | 13 | 9 | 327 | 210 |
| 106 | BB | 1241 | 59 | 812 | 109 | 11 | 11 | 12 | 321 | 208 |
| 107 | BC | 1247 | 55 | 826 | 129 | 12 | 19 | 12 | 329 | 202 |
| 108 | BD | 1258 | 48 | 818 | 104 | 10 | 14 | 6 | 320 | 201 |
| 109 | BE | 1252 | 60 | 824 | 68 | 12 | 103 | 9 | 328 | 216 |
| 110 | BF | 1231 | 48 | 822 | 137 | 15 | 92 | 11 | 324 | 208 |
| 111 | BG | 1247 | 43 | 828 | 56 | 14 | 17 | 9 | 313 | 201 |
| 112 | BH | 1257 | 44 | 823 | 119 | 13 | 12 | 12 | 333 | 228 |
| 113 | BI | 1232 | 42 | 827 | 74 | 15 | 18 | 18 | 320 | 205 |
| | | Heat treatment | | | | Heat treatment | | | | |
| | | B | | Working | | C | | | | |
| | | | Retaining | Equivalent | Number | | Average | Final | | |
| | | Temp. | time | plastic | of times | Temp. | cooling | sheet | | |
| | | T2 | t₂ | strain | of | T3 | rate v₄ | thickness | | |
| | No. | [° C.] | [s] | [%] | working | [° C.] | [° C./h] | [mm] | Type | Remarks |
| | 1 | 340 | 149 | 0.35 | 1 | 192 | 24.1 | 2.3 | CR | IE |
| | 2 | 302 | 297 | 0.58 | 1 | 175 | 7.7 | 1.4 | CR | IE |
| | 3 | 346 | 295 | 0.36 | 1 | 174 | 26.9 | 1.4 | CR | IE |
| | 4 | 313 | 215 | 0.41 | 1 | 193 | 30.4 | 1.4 | CR | IE |
| | 5 | 315 | 105 | 0.53 | 1 | 167 | 9.2 | 1.4 | CR | IE |
| | 6 | 315 | 113 | 0.53 | 1 | 177 | 33.1 | 1.4 | CR | IE |
| | 7 | 329 | 212 | 0.43 | 1 | 266 | 21.3 | 1.4 | CR | IE |
| | 8 | 309 | 227 | 0.48 | 1 | 169 | 9.1 | 1.4 | CR | IE |
| | 9 | 325 | 299 | 0.49 | 1 | 248 | 39.8 | 1.4 | CR | CE |
| | 10 | 308 | 296 | 0.33 | 1 | 210 | 34.4 | 1.4 | CR | IE |
| | 11 | 321 | 271 | 0.55 | 1 | 221 | 37.0 | 1.4 | CR | IE |
| | 12 | 324 | 212 | 0.33 | 1 | 199 | 29.4 | 1.4 | CR | IE |
| | 13 | 330 | 254 | 0.57 | 1 | 282 | 35.4 | 1.4 | CR | CE |
| | 14 | 201 | 126 | 0.34 | 1 | 258 | 36.6 | 1.4 | CR | IE |
| | 15 | 201 | 157 | 0.36 | 1 | 296 | 10.1 | 1.4 | CR | CE |
| | 16 | 349 | 143 | 0.58 | 1 | 163 | 11.0 | 1.4 | CR | IE |
| | 17 | 336 | 278 | 0.44 | 1 | 221 | 26.3 | 1.4 | CR | CE |
| | 18 | 315 | 297 | 0.58 | 2 | 287 | 10.6 | 1.4 | CR | IE |
| | 19 | 341 | 227 | 0.44 | 3 | 225 | 5.0 | 1.4 | CR | CE |
| | 20 | 331 | 229 | 0.46 | 1 | 168 | 32.0 | 1.4 | CR | IE |
| | 21 | 340 | 151 | 0.33 | 1 | 188 | 6.7 | 1.4 | CR | CE |
| | 22 | 321 | 136 | 0.52 | 1 | 268 | 18.8 | 1.4 | CR | IE |
| | 23 | 309 | 130 | 0.33 | 1 | 208 | 25.9 | 1.4 | CR | CE |
| | 24 | 338 | 276 | 0.32 | 1 | 250 | 8.1 | 1.4 | CR | IE |
| | 25 | 328 | 194 | 0.58 | 1 | 213 | 15.3 | 1.4 | CR | CE |
| | 26 | 322 | 297 | 0.35 | 1 | 254 | 21.1 | 1.4 | CR | IE |
| | 27 | 319 | 286 | 0.49 | 1 | 175 | 5.2 | 1.4 | CR | CE |
| | 28 | 308 | 189 | 0.51 | 1 | 254 | 11.1 | 1.4 | CR | IE |
| | 29 | 345 | 264 | 0.37 | 1 | 165 | 8.5 | 1.4 | CR | IE |
| | 30 | 416 | 189 | 0.55 | 1 | 295 | 17.0 | 1.4 | CR | IE |
| | 31 | 427 | 166 | 0.46 | 1 | 268 | 34.3 | 1.4 | CR | IE |
| | 32 | 311 | 5 | 0.41 | 1 | 253 | 6.6 | 1.4 | CR | IE |
| | 33 | 333 | 2 | 0.42 | 1 | 231 | 18.0 | 1.4 | CR | CE |
| | 34 | 329 | 815 | 0.32 | 1 | 279 | 12.4 | 1.4 | CR | IE |
| | 35 | 324 | 995 | 0.35 | 1 | 283 | 30.5 | 1.4 | CR | IE |
| | 36 | 326 | 292 | 0.12 | 1 | 256 | 13.3 | 1.4 | CR | IE |
| | 37 | 312 | 250 | 0.08 | 1 | 295 | 18.5 | 1.4 | CR | CE |
| | 38 | 324 | 174 | 4.93 | 1 | 279 | 38.8 | 1.4 | CR | IE |
| | 39 | 344 | 101 | 5.12 | 1 | 299 | 18.4 | 1.4 | CR | CE |
| | 40 | 325 | 231 | 0.57 | 1 | 249 | 36.1 | 1.4 | CR | IE |
| | 41 | 327 | 293 | 0.49 | 1 | 291 | 35.5 | 1.4 | CR | CE |
| | 42 | 334 | 159 | 0.49 | 1 | 199 | 5.6 | 1.4 | CR | IE |
| | 43 | 309 | 122 | 0.32 | 1 | 226 | 6.4 | 1.4 | CR | CE |
| | 44 | 311 | 154 | 0.35 | 1 | 151 | 32.0 | 1.4 | CR | IE |
| | 45 | 311 | 161 | 0.60 | 1 | 141 | 13.5 | 1.4 | CR | CE |
| | 46 | 304 | 135 | 0.53 | 1 | 388 | 28.7 | 1.4 | CR | IE |
| | 47 | 331 | 219 | 0.42 | 1 | 376 | 34.8 | 1.4 | CR | IE |
| | 48 | 318 | 130 | 0.36 | 1 | 152 | 3.0 | 1.4 | CR | IE |
| | 49 | 317 | 217 | 0.39 | 1 | 200 | 1.0 | 1.4 | CR | IE |
| | 50 | 321 | 147 | 0.31 | 1 | 192 | 44.0 | 1.4 | CR | IE |
| | 51 | 302 | 126 | 0.60 | 1 | 242 | 47.0 | 1.4 | CR | IE |
| | 52 | 310 | 285 | 0.50 | 2 | 294 | 22.6 | 1.4 | CR | IE |
| | 53 | 309 | 235 | 0.41 | 5 | 241 | 38.0 | 1.4 | CR | IE |
| | 54 | 304 | 228 | 0.47 | 1 | 227 | 17.9 | 1.4 | CR | IE |
| | 55 | 346 | 171 | 0.40 | 1 | 193 | 39.6 | 0.8 | CR | IE |
| | 56 | 200 | 146 | 0.34 | 1 | 230 | 36.3 | 1.5 | CR | IE |
| | 57 | 324 | 259 | 0.39 | 1 | 212 | 21.1 | 1.6 | CR | IE |
| | 58 | 329 | 125 | 0.51 | 1 | 208 | 24.8 | 1.6 | CR | IE |
| | 59 | 333 | 108 | 0.44 | 1 | 243 | 7.6 | 2.3 | GA | CE |
| | 60 | 317 | 248 | 0.39 | 1 | 193 | 19.6 | 0.9 | GA | IE |
| | 61 | 337 | 273 | 0.30 | 1 | 288 | 19.5 | 2.5 | GA | CE |
| | 62 | 335 | 142 | 0.50 | 1 | 280 | 8.3 | 1.6 | GA | IE |
| | 63 | 336 | 158 | 0.46 | 1 | 284 | 5.9 | 2.1 | GA | IE |
| | 64 | 302 | 131 | 0.53 | 1 | 282 | 13.7 | 1.6 | CR | IE |
| | 65 | 316 | 224 | 0.60 | 1 | 264 | 18.3 | 1.2 | CR | CE |
| | 66 | 323 | 142 | 0.56 | 1 | 173 | 26.2 | 1.9 | GA | IE |
| | 67 | 329 | 154 | 0.45 | 1 | 286 | 13.5 | 2.0 | GA | CE |
| | 68 | 327 | 242 | 0.40 | 1 | 286 | 23.3 | 2.0 | GI | IE |
| | 69 | 324 | 145 | 0.31 | 1 | 174 | 27.5 | 2.5 | GA | CE |
| | 70 | 302 | 108 | 0.37 | 1 | 274 | 34.0 | 1.7 | GA | IE |
| | 71 | 313 | 128 | 0.51 | 1 | 172 | 8.5 | 1.1 | GA | CE |
| | 72 | 334 | 273 | 0.54 | 1 | 292 | 30.1 | 2.4 | GA | IE |
| | 73 | 328 | 176 | 0.51 | 1 | 235 | 10.8 | 2.4 | GI | CE |
| | 74 | 325 | 179 | 0.43 | 1 | 155 | 26.7 | 2.2 | GA | IE |
| | 75 | 329 | 130 | 0.43 | 1 | 217 | 8.9 | 1.5 | GA | CE |
| | 76 | 317 | 253 | 0.35 | 1 | 271 | 23.3 | 1.0 | GA | IE |
| | 77 | 326 | 221 | 0.36 | 1 | 222 | 37.4 | 1.5 | GA | CE |
| | 78 | 349 | 277 | 0.60 | 1 | 194 | 21.1 | 1.2 | GA | IE |
| | 79 | 310 | 214 | 0.30 | 1 | 250 | 15.2 | 2.3 | GI | CE |
| | 80 | 333 | 161 | 0.52 | 1 | 156 | 16.3 | 1.4 | GA | IE |
| | 81 | 312 | 138 | 0.37 | 1 | 222 | 15.9 | 2.3 | GA | CE |
| | 82 | 327 | 152 | 0.47 | 1 | 218 | 28.2 | 2.0 | GA | IE |
| | 83 | 323 | 137 | 0.39 | 1 | 219 | 33.1 | 1.2 | GA | CE |
| | 84 | 315 | 163 | 0.55 | 1 | 295 | 13.1 | 1.8 | CR | IE |
| | 85 | 323 | 258 | 0.45 | 1 | 270 | 24.8 | 1.4 | CR | IE |
| | 86 | 345 | 275 | 0.48 | 1 | 213 | 28.9 | 1.2 | GA | CE |
| | 87 | 319 | 174 | 0.51 | 1 | 273 | 20.5 | 2.3 | GA | IE |
| | 88 | 317 | 196 | 0.46 | 1 | 261 | 29.9 | 2.0 | GA | IE |
| | 89 | 348 | 243 | 0.49 | 1 | 154 | 20.0 | 2.0 | GA | CE |
| | 90 | 324 | 225 | 0.35 | 1 | 297 | 26.4 | 1.8 | GA | IE |
| | 91 | 327 | 213 | 0.31 | 1 | 276 | 33.0 | 1.6 | GA | IE |
| | 92 | 309 | 125 | 0.31 | 1 | 201 | 17.5 | 2.5 | GA | CE |
| | 93 | 316 | 160 | 0.60 | 1 | 254 | 19.5 | 1.8 | CR | IE |
| | 94 | 327 | 122 | 0.30 | 1 | 277 | 23.1 | 0.9 | CR | IE |
| | 95 | 341 | 191 | 0.33 | 1 | 221 | 7.3 | 2.0 | CR | IE |
| | 96 | 336 | 294 | 0.48 | 1 | 283 | 19.8 | 0.9 | CR | IE |
| | 97 | 349 | 299 | 0.31 | 1 | 163 | 11.1 | 1.3 | CR | IE |
| | 98 | 350 | 123 | 0.35 | 1 | 235 | 7.5 | 2.2 | CR | IE |
| | 99 | 339 | 255 | 0.46 | 1 | 169 | 28.3 | 1.5 | CR | IE |
| | 100 | 326 | 289 | 0.51 | 1 | 256 | 20.0 | 1.0 | CR | IE |
| | 101 | 326 | 215 | 0.43 | 1 | 182 | 26.1 | 1.6 | CR | IE |
| | 102 | 303 | 101 | 0.35 | 1 | 177 | 32.9 | 1.7 | CR | IE |
| | 103 | 439 | 279 | 0.32 | 1 | 234 | 18.2 | 2.5 | CR | IE |
| | 104 | 327 | 8 | 0.41 | 1 | 220 | 36.5 | 2.2 | CR | IE |
| | 105 | 343 | 927 | 0.56 | 1 | 196 | 11.2 | 2.1 | CR | IE |
| | 106 | 339 | 120 | 0.14 | 1 | 230 | 25.6 | 2.4 | CR | IE |
| | 107 | 313 | 103 | 4.21 | 1 | 178 | 8.7 | 0.8 | CR | IE |
| | 108 | 340 | 259 | 0.33 | 1 | 253 | 31.7 | 0.9 | CR | IE |
| | 109 | 226 | 183 | 0.33 | 1 | 159 | 23.4 | 1.5 | CR | IE |
| | 110 | 325 | 263 | 0.37 | 1 | 250 | 18.3 | 1.9 | EG | IE |
| | 111 | 327 | 276 | 0.34 | 1 | 276 | 14.5 | 1.4 | EG | IE |
| | 112 | 321 | 229 | 0.49 | 1 | 293 | 17.5 | 1.9 | EG | IE |
| | 113 | 320 | 194 | 0.60 | 1 | 187 | 23.4 | 2.1 | EG | IE |

IE: Inventive Example
CE: Comparative Example

TABLE 3

| | | Final | | Amount | Total | | | | | | | |
|---|---|---|---|---|---|---|---|---|---|---|---|---|
| | | sheet | | of | amount | Insta- | Insta- | | | Delayed | | |
| | Type | thick- | Amount | retained | of F | bility | bility | | | fracture | Optimal | |
| | of | ness | of M | γ | and BF | index | index | TS | El | re- | clearance | Re- |
| No. | steel | [mm] | [%] | [%] | [%] | k | d | [MPa] | [%] | sistance | range | marks |
| 1 | A | 2.3 | 71 | 11 | 18 | 3.2 | 0.2 | 1069 | 23 | A | A | IE |
| 2 | B | 1.4 | 74 | 9 | 17 | 2.6 | −2.2 | 1271 | 16 | A | A | IE |
| 3 | B | 1.4 | 73 | 8 | 19 | 2.9 | −0.9 | 1171 | 18 | A | A | IE |
| 4 | B | 1.4 | 73 | 9 | 18 | 3.4 | −1.2 | 1221 | 18 | B | A | IE |
| 5 | B | 1.4 | 75 | 9 | 16 | 2.1 | −1.7 | 1321 | 15 | B | A | IE |
| 6 | B | 1.4 | 76 | 9 | 15 | 2.7 | −1.0 | 1371 | 14 | A | A | IE |
| 7 | B | 1.4 | 69 | 11 | 20 | 2.3 | 0.0 | 1021 | 26 | A | A | IE |
| 8 | B | 1.4 | 69 | 11 | 20 | 4.6 | −1.2 | 1071 | 24 | A | B | IE |
| 9 | B | 1.4 | 75 | 9 | 16 | 6.0 | −0.1 | 1321 | 15 | A | C | CE |
| 10 | B | 1.4 | 72 | 10 | 18 | 2.5 | 1.5 | 1121 | 20 | A | A | IE |
| 11 | B | 1.4 | 73 | 10 | 17 | 2.1 | −0.9 | 1171 | 19 | A | A | IE |
| 12 | B | 1.4 | 61 | 8 | 31 | 3.3 | −1.4 | 997 | 34 | A | A | IE |
| 13 | B | 1.4 | 51 | 9 | 40 | 2.1 | −0.1 | 942 | 32 | A | A | CE |
| 14 | B | 1.4 | 78 | 10 | 12 | 2.4 | 1.7 | 1471 | 9 | A | A | IE |
| 15 | B | 1.4 | 82 | 11 | 7 | 2.3 | −2.1 | 1671 | 7 | A | A | CE |
| 16 | B | 1.4 | 62 | 8 | 30 | 3.3 | −2.0 | 1020 | 32 | A | A | IE |
| 17 | B | 1.4 | 55 | 9 | 36 | 3.0 | 2.0 | 893 | 36 | A | A | CE |
| 18 | B | 1.4 | 80 | 9 | 11 | 2.0 | −2.3 | 1571 | 9 | A | A | IE |
| 19 | B | 1.4 | 83 | 9 | 8 | 2.9 | 2.3 | 1721 | 6 | A | A | CE |
| 20 | B | 1.4 | 78 | 11 | 11 | 2.9 | −2.3 | 1471 | 8 | A | A | IE |
| 21 | B | 1.4 | 80 | 11 | 9 | 2.5 | 0.8 | 1571 | 7 | A | A | CE |
| 22 | B | 1.4 | 69 | 12 | 19 | 2.3 | 4.6 | 1071 | 25 | B | B | IE |
| 23 | B | 1.4 | 66 | 17 | 17 | 4.9 | 5.8 | 1321 | 16 | C | C | CE |
| 24 | B | 1.4 | 81 | 5 | 14 | 3.4 | −0.4 | 1571 | 9 | A | A | IE |
| 25 | B | 1.4 | 83 | 2 | 15 | 2.4 | 1.5 | 1542 | 6 | A | A | CE |
| 26 | B | 1.4 | 67 | 19 | 14 | 3.0 | −0.2 | 1221 | 18 | B | A | IE |
| 27 | B | 1.4 | 64 | 22 | 14 | 3.0 | −1.8 | 1071 | 24 | C | A | CE |
| 28 | B | 1.4 | 74 | 8 | 18 | 2.5 | −2.0 | 1221 | 17 | A | A | IE |
| 29 | B | 1.4 | 77 | 8 | 15 | 2.9 | 1.8 | 1421 | 12 | A | A | IE |
| 30 | B | 1.4 | 69 | 12 | 19 | 3.5 | −0.8 | 1003 | 26 | A | A | IE |
| 31 | B | 1.4 | 75 | 8 | 17 | 2.8 | 0.5 | 1012 | 19 | A | A | IE |
| 32 | B | 1.4 | 72 | 9 | 19 | 4.5 | 1.7 | 1171 | 19 | A | B | IE |
| 33 | B | 1.4 | 74 | 8 | 18 | 6.8 | 1.7 | 1271 | 16 | A | C | CE |
| 34 | B | 1.4 | 70 | 12 | 18 | 2.1 | −2.8 | 986 | 26 | A | A | IE |
| 35 | B | 1.4 | 71 | 11 | 18 | 3.1 | −3.0 | 988 | 24 | A | A | IE |
| 36 | B | 1.4 | 75 | 10 | 15 | 3.2 | 4.9 | 1271 | 16 | B | B | IE |
| 37 | B | 1.4 | 74 | 10 | 16 | 4.8 | 6.1 | 1321 | 16 | C | C | CE |
| 38 | B | 1.4 | 75 | 5 | 20 | 2.1 | −0.8 | 1221 | 9 | A | A | IE |
| 39 | B | 1.4 | 80 | 2 | 18 | 3.0 | −1.6 | 1471 | 7 | A | A | CE |
| 40 | B | 1.4 | 75 | 10 | 15 | 2.4 | 4.5 | 1271 | 16 | B | B | IE |
| 41 | B | 1.4 | 73 | 12 | 15 | 4.7 | 6.2 | 1221 | 18 | C | C | CE |
| 42 | B | 1.4 | 79 | 6 | 15 | 2.1 | −10.2 | 1371 | 10 | A | A | IE |
| 43 | B | 1.4 | 84 | 2 | 14 | 3.1 | −9.2 | 1371 | 5 | A | A | CE |
| 44 | B | 1.4 | 74 | 10 | 16 | 4.9 | −2.5 | 1271 | 16 | A | B | IE |
| 45 | B | 1.4 | 72 | 11 | 17 | 9.4 | 0.6 | 1171 | 20 | A | C | CE |
| 46 | B | 1.4 | 77 | 9 | 14 | 2.0 | 2.4 | 1002 | 18 | A | A | IE |
| 47 | B | 1.4 | 75 | 11 | 14 | 3.3 | 1.0 | 993 | 20 | A | A | IE |
| 48 | B | 1.4 | 73 | 12 | 15 | 2.7 | 1.8 | 1271 | 18 | A | A | IE |
| 49 | B | 1.4 | 73 | 10 | 17 | 3.3 | 2.4 | 1221 | 18 | A | A | IE |
| 50 | B | 1.4 | 73 | 11 | 16 | 4.6 | −0.7 | 1115 | 22 | A | B | IE |
| 51 | B | 1.4 | 75 | 10 | 15 | 4.8 | 0.7 | 1094 | 20 | A | B | IE |
| 52 | B | 1.4 | 69 | 12 | 19 | 3.1 | −0.7 | 1021 | 26 | A | A | IE |
| 53 | B | 1.4 | 71 | 9 | 20 | 2.1 | 3.0 | 1121 | 21 | A | A | IE |
| 54 | B | 1.4 | 69 | 11 | 20 | 2.5 | −2.5 | 1021 | 26 | A | A | IE |
| 55 | C | 0.8 | 71 | 10 | 19 | 2.8 | −2.2 | 1115 | 21 | A | A | IE |
| 56 | D | 1.5 | 72 | 9 | 19 | 2.0 | −2.8 | 1219 | 19 | A | A | IE |
| 57 | E | 1.6 | 74 | 11 | 15 | 3.0 | 2.5 | 1267 | 17 | A | A | IE |
| 58 | F | 1.6 | 63 | 8 | 29 | 2.1 | 0.9 | 991 | 32 | A | A | IE |
| 59 | G | 2.3 | 52 | 11 | 37 | 2.1 | 1.7 | 932 | 36 | A | A | CE |
| 60 | H | 0.9 | 74 | 10 | 16 | 2.6 | 2.0 | 1684 | 9 | B | A | IE |
| 61 | I | 2.5 | 71 | 11 | 18 | 3.5 | 1.2 | 1716 | 8 | C | A | CE |
| 62 | J | 1.6 | 76 | 8 | 16 | 3.1 | −2.7 | 990 | 19 | A | A | IE |
| 63 | K | 2.1 | 76 | 10 | 14 | 2.1 | −0.3 | 904 | 21 | A | A | CE |
| 64 | L | 1.6 | 68 | 18 | 14 | 3.2 | 1.4 | 1261 | 19 | B | A | IE |
| 65 | M | 1.2 | 64 | 21 | 15 | 2.2 | −2.4 | 1124 | 24 | C | A | CE |
| 66 | N | 1.9 | 63 | 8 | 29 | 3.1 | −0.3 | 998 | 32 | A | A | IE |
| 67 | O | 2.0 | 52 | 10 | 38 | 2.3 | −0.8 | 938 | 32 | A | A | CE |
| 68 | P | 2.0 | 71 | 11 | 18 | 3.1 | 1.8 | 1274 | 19 | B | A | IE |
| 69 | Q | 2.5 | 71 | 12 | 17 | 2.8 | 1.9 | 1287 | 19 | C | A | CE |
| 70 | R | 1.7 | 70 | 11 | 19 | 2.9 | 2.4 | 1105 | 23 | B | A | IE |
| 71 | S | 1.1 | 74 | 11 | 15 | 3.4 | 2.0 | 1262 | 17 | C | A | CE |
| 72 | T | 2.4 | 70 | 10 | 20 | 3.2 | −0.7 | 1025 | 24 | B | A | IE |
| 73 | U | 2.4 | 74 | 10 | 16 | 2.5 | −1.1 | 1259 | 17 | C | A | CE |
| 74 | V | 2.2 | 70 | 10 | 20 | 3.1 | −1.5 | 1067 | 23 | B | A | IE |
| 75 | W | 1.5 | 72 | 11 | 17 | 2.3 | −2.9 | 1170 | 20 | C | A | CE |
| 76 | X | 1.0 | 75 | 9 | 16 | 3.3 | 0.4 | 1467 | 13 | B | A | IE |
| 77 | Y | 1.5 | 72 | 11 | 17 | 2.9 | −0.7 | 1203 | 19 | C | A | CE |
| 78 | Z | 1.2 | 72 | 10 | 18 | 2.4 | 2.9 | 1223 | 19 | B | A | IE |
| 79 | AA | 2.3 | 72 | 11 | 17 | 2.6 | −0.1 | 1221 | 19 | C | A | CE |
| 80 | AB | 1.4 | 71 | 10 | 19 | 4.6 | −0.7 | 1122 | 21 | A | B | IE |
| 81 | AC | 2.3 | 69 | 11 | 20 | 5.9 | 2.8 | 1007 | 26 | A | C | CE |
| 82 | AD | 2.0 | 72 | 10 | 18 | 2.6 | −2.4 | 1224 | 19 | B | A | IE |
| 83 | AE | 1.2 | 73 | 11 | 16 | 2.8 | −1.1 | 1253 | 18 | C | A | CE |
| 84 | AF | 1.8 | 69 | 12 | 19 | 2.2 | 0.2 | 1010 | 26 | A | A | IE |
| 85 | AG | 1.4 | 72 | 11 | 17 | 3.2 | −1.5 | 1158 | 20 | B | A | IE |
| 86 | AH | 1.2 | 72 | 9 | 19 | 2.7 | 1.5 | 1603 | 9 | C | A | CE |
| 87 | AI | 2.3 | 72 | 9 | 19 | 2.9 | 1.1 | 1016 | 22 | A | A | IE |
| 88 | AJ | 2.0 | 71 | 9 | 20 | 2.5 | 2.8 | 1090 | 22 | B | A | IE |
| 89 | AK | 2.0 | 72 | 10 | 18 | 2.7 | 0.8 | 1648 | 8 | C | A | CE |
| 90 | AL | 1.8 | 70 | 10 | 20 | 3.0 | 2.5 | 1011 | 25 | A | A | IE |
| 91 | AM | 1.6 | 73 | 8 | 19 | 2.1 | 1.4 | 1213 | 18 | B | A | IE |
| 92 | AN | 2.5 | 74 | 11 | 15 | 3.0 | 2.7 | 1663 | 9 | C | A | CE |
| 93 | AO | 1.8 | 72 | 10 | 18 | 2.1 | 0.5 | 1204 | 19 | A | A | IE |
| 94 | AP | 0.9 | 73 | 8 | 19 | 4.9 | 0.0 | 1276 | 17 | A | B | IE |
| 95 | AQ | 2.0 | 63 | 8 | 29 | 2.2 | 2.3 | 1009 | 31 | A | A | IE |
| 96 | AR | 0.9 | 62 | 9 | 29 | 2.5 | −1.3 | 1019 | 32 | A | A | IE |
| 97 | AS | 1.3 | 77 | 11 | 12 | 2.9 | 0.3 | 1122 | 8 | A | A | IE |
| 98 | AT | 2.2 | 70 | 12 | 18 | 4.5 | 4.9 | 1086 | 23 | B | B | IE |
| 99 | AU | 1.5 | 79 | 4 | 17 | 3.2 | 1.3 | 1361 | 8 | A | A | IE |
| 100 | AV | 1.0 | 62 | 18 | 20 | 2.4 | 1.3 | 958 | 31 | B | A | IE |
| 101 | AW | 1.6 | 70 | 11 | 19 | 2.9 | 0.6 | 1125 | 22 | A | A | IE |
| 102 | AX | 1.7 | 76 | 9 | 15 | 2.9 | −1.6 | 1310 | 14 | A | A | IE |
| 103 | AY | 2.5 | 77 | 8 | 15 | 3.0 | 2.6 | 1019 | 17 | A | A | IE |
| 104 | AZ | 2.2 | 71 | 10 | 19 | 4.7 | 1.9 | 1186 | 20 | A | B | IE |
| 105 | BA | 2.1 | 73 | 11 | 16 | 2.8 | −0.2 | 1017 | 22 | A | A | IE |
| 106 | BB | 2.4 | 71 | 12 | 17 | 3.3 | 4.6 | 1210 | 20 | B | B | IE |
| 107 | BC | 0.8 | 77 | 5 | 18 | 2.1 | 1.7 | 1388 | 9 | A | A | IE |
| 108 | BD | 0.9 | 77 | 9 | 14 | 4.7 | 4.7 | 1406 | 13 | B | B | IE |
| 109 | BE | 1.5 | 71 | 10 | 19 | 3.1 | −0.5 | 1197 | 20 | A | A | IE |
| 110 | BF | 1.9 | 72 | 12 | 16 | 2.9 | 0.6 | 1150 | 20 | A | A | IE |
| 111 | BG | 1.4 | 70 | 10 | 20 | 2.0 | −2.6 | 1049 | 24 | A | A | IE |
| 112 | BH | 1.9 | 75 | 8 | 17 | 2.9 | 1.7 | 1308 | 15 | A | A | IE |
| 113 | BI | 2.1 | 72 | 9 | 19 | 2.9 | −0.1 | 1168 | 19 | A | A | IE |

IE: Inventive Example
CE: Comparative Example

### <Summary of Evaluation Results>

As shown in Table 3 above, the steel sheets of Nos. 1 to 8, 10 to 12, 14, 16, 18, 20, 22, 24, 26, 28 to 32, 34 to 36, 38, 40, 42, 44, 46 to 58, 60, 62, 64, 66, 68, 70, 72, 74, 76, 78, 80, 82, 84, 85, 87, 88, 90, 91, and 93 to 113 (Inventive Examples) had a TS of not less than 980 MPa, excellent ductility and excellent delayed fracture resistance, and a wide optimal clearance range.

In contrast, the steel sheets of Nos. 9, 13, 15, 17, 19, 21, 23, 25, 27, 33, 37, 39, 41, 43, 45, 59, 61, 63, 65, 67, 69, 71, 73, 75, 77, 79, 81, 83, 86, 89, and 92 (Comparative Examples) were insufficient in at least one of TS, ductility, delayed fracture resistance, or optimal clearance range.

1. A high strength steel sheet comprising a steel sheet,
wherein the steel sheet has a chemical composition including, by mass,
C in an amount of not less than 0.030% and not more than 0.500%,
Si in an amount of not less than 0.50% and not more than 2.50%,
Mn in an amount of not less than 1.50% and not more than 5.00%,
P in an amount of not more than 0.100%
S in an amount of not more than 0.0200%,
Al in an amount of not more than 1.000%,
N in an amount of not more than 0.0100%,
O in an amount of not more than 0.0100%, and
Nb in an amount of not less than 0.005% and not more than 0.100%,
with a balance consisting of Fe and inevitable impurities,
the steel sheet has a microstructure in which an amount of martensite is not less than 60%, an amount of retained austenite is not less than 3% and not more than 20%, and a total amount of ferrite and bainitic ferrite is more than 10%,
an instability index k of retained austenite is less than 5.9, and
an instability index d of retained austenite in an initial stage of working is less than 5.8.

2. The high strength steel sheet according to claim 1,
wherein the chemical composition further includes at least one element selected from the group consisting of, by mass,
Ti in an amount of not more than 0.200%,
V in an amount of not more than 0.200%,
Ta in an amount of not more than 0.10%,
W in an amount of not more than 0.10%,
B in an amount of not more than 0.0100%,
Cr in an amount of not more than 1.00%,
Mo in an amount of not more than 1.00%,
Ni in an amount of not more than 1.00%,
Co in an amount of not more than 0.010%,
Cu in an amount of not more than 1.00%,
Sn in an amount of not more than 0.200%,
Sb in an amount of not more than 0.200%,
Ca in an amount of not more than 0.0100%,
Mg in an amount of not more than 0.0100%,
REM in an amount of not more than 0.0100%,
Zr in an amount of not more than 0.100%,
Te in an amount of not more than 0.100%,
Hf in an amount of not more than 0.10%, and
Bi in an amount of not more than 0.200%.

3. The high strength steel sheet according to claim 1, further comprising a plating layer on a surface of the steel sheet.

4. A method for manufacturing the high strength steel sheet according to claim 1, the method comprising:
retaining a steel slab having the chemical composition according to claim 1 at a slab heating temperature of not lower than 1,220° C. and then performing hot rolling to obtain a hot rolled steel sheet;
cooling the hot rolled steel sheet under a condition of an average cooling rate v₁ from 800° C. to 600° C. of not lower than 30° C./s and then performing pickling and cold rolling to obtain a cold rolled steel sheet;
performing a heat treatment A in which the cold rolled steel sheet is retained at a temperature T1 of not lower than 750° C. and not higher than 900° C. for 10 seconds or more and 1,000 seconds or less and then cooled to a cooling stop temperature Ta of not lower than 100° C. and not higher than (Ms point−80° C.),
where, in the heat treatment A, an average cooling rate v₂ from 750° C. to 600° C. is lower than 20° C./s, an average cooling rate v₃ from the Ms point to the cooling stop temperature Ta is not higher than 150° C./s, and a tension F imparted to the cold rolled steel sheet from the Ms point to the cooling stop temperature Ta is not less than 5 MPa and not more than 100 MPa;
after the heat treatment A, performing a heat treatment B in which the cold rolled steel sheet is retained at a temperature T2 of not lower than the cooling stop temperature Ta and not higher than 450° C. for 5 seconds or more and 1,000 seconds or less and then cooled;
after the heat treatment B, performing a heat treatment C in which the cold rolled steel sheet is heated to a temperature T3 of not lower than 150° C. and not higher than 400° C. and then cooled without being retained at the temperature T3,
where, in the heat treatment C, an average cooling rate v₄ from 150° C. to 50° C. is not lower than 1.0° C./s and not higher than 50.0° C./s; and
after the heat treatment A and before the heat treatment C, working the cold rolled steel sheet to impart an equivalent plastic strain of not less than 0.10% and not more than 5.00% to the cold rolled steel sheet,
wherein the Ms point is represented in a unit of ° C. and determined by Formula (a):
$$Ms = 519 - 474 \times [ \% C ] - 30.4 \times [ \% Mn ] - 12.1 \times [ \% Cr ] - 7.5 \times [ \% Mo ] - 17.7 \times [ \% Ni ] \qquad ( a )$$
in Formula (a), [% M] represents a content of an element M in the chemical composition, and when the element M is not contained, [% M] is 0.

5. The method for manufacturing the high strength steel sheet according to claim 4,
wherein the cold rolled steel sheet is subjected to a plating treatment.

6. The high strength steel sheet according to claim 2, further comprising a plating layer on a surface of the steel sheet.

7. A method for manufacturing the high strength steel sheet according to claim 2, the method comprising:
retaining a steel slab having the chemical composition according to claim 2 at a slab heating temperature of not lower than 1,220° C. and then performing hot rolling to obtain a hot rolled steel sheet;
cooling the hot rolled steel sheet under a condition of an average cooling rate v₁ from 800° C. to 600° C. of not lower than 30° C./s and then performing pickling and cold rolling to obtain a cold rolled steel sheet;
performing a heat treatment A in which the cold rolled steel sheet is retained at a temperature T1 of not lower than 750° C. and not higher than 900° C. for 10 seconds or more and 1,000 seconds or less and then cooled to a cooling stop temperature Ta of not lower than 100° C. and not higher than (Ms point−80° C.),
where, in the heat treatment A, an average cooling rate v₂ from 750° C. to 600° C. is lower than 20° C./s, an average cooling rate v₃ from the Ms point to the cooling stop temperature Ta is not higher than 150° C./s, and a tension F imparted to the cold rolled steel sheet from the Ms point to the cooling stop temperature Ta is not less than 5 MPa and not more than 100 MPa;
after the heat treatment A, performing a heat treatment B in which the cold rolled steel sheet is retained at a temperature T2 of not lower than the cooling stop temperature Ta and not higher than 450° C. for 5 seconds or more and 1,000 seconds or less and then cooled;
after the heat treatment B, performing a heat treatment C in which the cold rolled steel sheet is heated to a temperature T3 of not lower than 150° C. and not higher than 400° C. and then cooled without being retained at the temperature T3,
where, in the heat treatment C, an average cooling rate v₄ from 150° C. to 50° C. is not lower than 1.0° C./s and not higher than 50.0° C./s; and
after the heat treatment A and before the heat treatment C, working the cold rolled steel sheet to impart an equivalent plastic strain of not less than 0.10% and not more than 5.00% to the cold rolled steel sheet,
wherein the Ms point is represented in a unit of ° C. and determined by Formula (a):
$$Ms = 519 - 474 \times [ \% C ] - 30.4 \times [ \% Mn ] - 12.1 \times [ \% Cr ] - 7.5 \times [ \% Mo ] - 17.7 \times [ \% Ni ] \qquad ( a )$$
in Formula (a), [% M] represents a content of an element M in the chemical composition, and when the element M is not contained, [% M] is 0.

8. The method for manufacturing the high strength steel sheet according to claim 7,
wherein the cold rolled steel sheet is subjected to a plating treatment.
